(19) United States
(12) Patent Application Publication
(10) Pub. No.: US 2010/0257965 A1
(43) Pub. Date: Oct. 14, 2010

(54) DOUBLE CLUTCH TRANSMISSION

(75) Inventors: Wolfgang RIEGER, Friedrichshafen (DE); Philip RECKER, Friedrichshafen (DE); Gerhard GUMPOLTSBERGER, Friedrichshafen (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/758,994

(22) Filed: Apr. 13, 2010

(30) Foreign Application Priority Data
Apr. 14, 2009 (DE) 10 2009 002 356.9

(51) Int. Cl. F16H 3/20

(52) U.S. Cl. 74/331

(57) ABSTRACT

A double clutch transmission comprising two clutches (K1, K2) with input sides connected to a drive shaft (w_an) and output sides respectively connected to one of two coaxially disposed transmission input shafts (w_k1, w_k2). At least two countershafts (w_v1, w_v2) are provided on which toothed idler gearwheels (7, 8, 9, 10, 11, 14, 15, 16, 18) are mounted. The toothed fixed gearwheels (1, 2, 3, 4, 5, 6) are disposed on the first and the second transmission input shafts (w_k1, w_k2). At least one shift element (M) is provided for connecting two toothed gearwheels in a rotationally fixed manner and several power shiftable forward gears (1, 2, 3, 4, 5, 6, 7, 8) and at least one reverse gear (R1, R2, R3) can be shifted. A maximum of six gear planes (7-1, 8-14, 9-15, 10-16, 11-5, 6-18) are provided so that at least one power shiftable winding path gear (G1, R2, O2) can be shifted by at least one shift element (M).

This application claims priority from German patent application serial no. 10 2009 002 356.9 filed Apr. 14, 2009.

### FIELD OF THE INVENTION

The present invention relates to a double clutch transmission.

### BACKGROUND OF THE INVENTION

A six-speed or seven-speed double clutch transmission is known from the publication DE 103 05 241 A1. The double clutch transmission comprises two clutches, which in each case are connected, on the input sides thereof, to the drive shaft and, on the output sides thereof, to one of the two transmission input shafts. The two transmission input shafts are arranged coaxially to one another. Furthermore, two countershafts are arranged axially parallel to the two transmission input shafts, the idler gears of which mesh with fixed gears of the transmission input shafts. In addition, coupling devices are held in a rotationally fixed manner on the countershafts in an axially displaceable manner in order to shift the respective toothed gearwheels. The transmission ratio selected in each case is transmitted by way of the output gears to a differential. In order to implement the desired transmission ratio steps in the known double clutch transmission, a plurality of gear planes are required, thereby making a significant construction space necessary during installation.

Furthermore, a spur-gear multi-speed transmission is known from the publication DE 38 22 330 A1. The spur-gear multi-speed transmission comprises a power shiftable double clutch, the one part of which is connected to a drive shaft and the other part of which is connected to a hollow drive shaft rotatably mounted on the drive shaft. For certain transmission ratios, the drive shaft can be coupled to the hollow drive shaft by way of a shift element.

A power-shift transmission having two clutches, each being associated with a subtransmission, is known from the publication DE 10 2004 001 961 A1. The transmission input shafts of the two subtransmissions are arranged coaxially to one another and mesh with idler gears of the associated countershafts by way of fixed gears. The respective idler gears of the countershafts can be connected in a rotationally fixed manner to the respective countershaft by means of associated shift elements. From this publication, an eight-speed transmission is known, in which a further shift element is provided for coupling the two transmission input shafts so as to implement a further transmission ratio step. In this embodiment, the seven-speed transmission requires at least six gear planes in the two subtransmissions in order to implement the transmission ratio steps. This undesirably increases the length in the axial direction, thereby considerably limiting the installation possibility in a vehicle.

Furthermore, another power-shift transmission comprising two input shafts and only one countershaft is known from the publication DE 10 2005 028 532 A1. An eight-speed transmission in this embodiment requires more than seven gear planes, in order to implement the transmission ratio steps, in particular the reverse gear transmission ratios. This undesirably increases the length in the axial direction.

### SUMMARY OF THE INVENTION

It is the object of the present invention to propose a double clutch transmission of the type described above, in which several power shiftable transmission ratio steps can be implemented in the most cost-effective manner and with the fewest components possible, while requiring little construction space.

A construction space-optimized double clutch transmission having two clutches is therefore proposed, the input sides of which are connected to a drive shaft and the output sides of which are each respectively connected to one of two transmission input shafts which are arranged coaxially to one another. The double clutch transmission comprises at least two countershafts or the like, on which toothed gearwheels designed as idler gears are rotatably mounted, wherein on the two transmission input shafts, rotationally fixed toothed gearwheels designed as fixed gears are provided, at least some of which mesh with the idler gears. Furthermore, a plurality of coupling devices are provided for connecting an idler gear to a countershaft in a rotationally fixed manner. The double clutch transmission according to the invention comprises an output gear, or constant pinion, which is provided on each of the countershafts and which is coupled to gearing of a drive shaft to connect the respective countershaft to the output drive, and it further comprises at least one shift element for connecting two toothed gearwheels in a rotationally fixed manner, wherein several power shiftable gears can be implemented.

According to the invention, the proposed double clutch transmission preferably comprises a maximum of six gear planes, by which at least eight power shiftable gears are implemented with low construction space requirement. For example, the maximum of six gear planes can preferably be formed by three dual gear planes and three single gear planes. Other configurations are also possible. In each dual gear plane, idler gears of the first and second countershafts are associated with a fixed gear of one of the transmission input shafts, wherein in at least one of dual gear planes at least one idler gear can be used for at least two gears. In the single gear planes, an idler gear of one of the countershafts is associated with a fixed gear of one of the transmission input shafts. In the proposed double clutch transmission, at least one winding path gear can be shifted by way of an activated winding path gear shift element.

Due to the possible multiple uses of idler gears, in the proposed double clutch transmission it is possible to implement a maximum number of transmission ratios with the fewest gear planes possible, wherein preferably the first eight forward gears can be power shifted with sequential execution.

In order to optimize the gradation in the double clutch transmission proposed according to the invention, a dual gear plane can be replaced by two single gear planes, for example, and a fixed gear is replaced by two fixed gears. In this way, particularly smooth, progressive gear stepping can be achieved. It is also possible to replace two single gear planes by a dual gear plane.

The proposed double clutch transmission can preferably be implemented as an 8-speed transmission having at least eight power shiftable gear steps. However, it is also possible to implement transmissions having different numbers of gears. Due to the shortened design compared to known transmission arrangements, the double clutch transmission according to the invention is particularly suited for a front-transverse design of a vehicle. However, other installations are also conceivable, depending on the type and construction space situation of the vehicle in question in each case.

In the proposed double clutch transmission, the first or eighth forward gears can preferably be a winding path gear. In addition, at least one reverse gear and/or other gears, such as crawler gears or overdrive gears, can likewise be designed as winding path gears and possibly be implemented in a power shiftable manner. For example, the first power shiftable forward gear or the highest power shiftable gear can be a winding path gear.

In the proposed double clutch transmission, at least one countershaft can be associated with at least one winding path gear shift element to implement the winding path gears. Optionally, further winding path gear shift elements can be provided in the form of shift elements associated with the first or the second countershaft, or also in the form of winding path gear coupling devices, which are quasi associated as winding path gear shift elements with the constant pinions to detach them from the associated countershaft so as to implement further winding path gears. In this way, optionally both constant pinions can be shiftably connected to the associated countershaft.

Depending on the embodiment, three to five shiftable idler gears can be associated with the first countershaft and four to six shiftable idler gears can be associated with the second countershaft, wherein the idler gears, in each case, mesh with fixed gears of the associated transmission input shafts.

If the last, or second to the last, gear increment is designed to be higher than the one respectively before that, a particularly high output torque or drive power can be provided during a downshift requested by the driver.

According to the invention, it is possible to connect the idler gear of the second subtransmission to the idler gear of the first subtransmission by way of the one, or also by way of at least one additional, shift element on the first and/or second countershafts, thereby allowing the shift element to shift at least one winding path gear.

With the double clutch transmission according to the invention, when the shift element is activated and, if necessary, additionally the coupling devices are disengaged, in this way, at the output gears, winding path gears can be implemented in which the toothed gearwheels of both subtransmissions are coupled to one another in order to thereby achieve a flow of power through both subtransmissions. The respective winding path gear shift element is used to couple two idler gears, thereby making the transmission input shafts dependent on one another.

In the double clutch transmission, the arrangement of the shift elements for coupling two defined idler gears can be varied, so that the shift elements do not necessarily have to be disposed between the idler gears to be coupled. Accordingly, other arrangement positions of the respective shift element are conceivable in order to optimize linking to an actuator system.

In the proposed double clutch transmission, preferably at least one additional gear stage ZW_x is provided, which is not used in any other forward gear.

According to a possible embodiment of the invention, the fixed gears of the second transmission input shaft of the second subtransmission are associated with a first gear plane designed as a single gear plane, a second gear plane designed as a dual gear plane, and a third gear plane designed as a dual gear plane, and the fixed gears of the first transmission input shaft of the first subtransmission are associated with a fourth gear plane designed as a dual gear plane, a fifth gear plane designed as a single gear plane, and a sixth gear plane designed as a single gear plane.

Within the scope of a further embodiment of the invention, the fixed gears of the second transmission input shaft of the second subtransmission can be associated with a first gear plane designed as a dual gear plane, a second gear plane designed as a single gear plane, and a third gear plane designed as a dual gear plane, and the fixed gears of the first transmission input shaft of the second subtransmission can be associated with a fourth gear plane designed as a dual gear plane, a fifth gear plane designed as a single gear plane, and a sixth gear plane designed as a single gear plane.

Preferably, in the double clutch transmission according to the invention, the fixed gears of the second transmission input shaft of the second subtransmission can be associated with a first gear plane designed as a single gear plane, a second gear plane designed as a single gear plane, and a third gear plane designed as a dual gear plane, and the fixed gears of the first transmission input shaft of the first subtransmission can be associated with a fourth gear plane designed as a dual gear plane, a fifth gear plane designed as a dual gear plane, and a sixth gear plane designed as a single gear plane.

In order to provide for the necessary reversal of rotation for implementing reverse gears in the double clutch transmission according to the invention, at least one intermediate gear or the like can be used which is disposed on an intermediate shaft. It is also possible that one of the idler gears of a countershaft serves as an intermediate gear for at least one reverse gear. For the reverse gear transmission ratio, in this case, no additional intermediate shaft is required, since one of the idler gears meshes both with a fixed gear and with a further shiftable idler gear of the other countershaft. In this way, the intermediate gear required for the reverse gear is positioned as a shiftable idler gear on a countershaft, and additionally is used to implement at least one further forward gear. The intermediate gear can also be designed as a stepped gear, independent of whether it is arranged on the countershaft or on an additional intermediate shaft. It is also possible that the intermediate gear is not arranged on one of the existing countershafts, but that it is provided, for example, on a further separate shaft, such as a third countershaft.

In order to obtain the desired transmission ratio steps, in the double clutch transmission according to the invention at least one bidirectionally operative coupling device or the like can be arranged on each countershaft. In the activated or engaged state, depending on the actuating direction, the provided coupling devices can connect an associated idler gear in a rotationally fixed manner to the countershaft. In addition, a coupling device operative in one direction or the like may be arranged on at least one of the countershafts. The coupling devices used can be hydraulically, electrically, pneumatically, or mechanically actuated clutches, for example, or also form-locking dog clutches, and any type of synchronizer devices, which are used to connect an idler gear to a countershaft in a rotationally fixed manner. It is possible to replace a bidirectionally operative coupling device with two coupling devices that are operative in one direction, or conversely.

It is conceivable to vary the listed arrangement possibilities of the toothed gearwheels and to change the number of the toothed gearwheels and the number of the coupling devices to implement additional power shiftable and non-power shiftable gears and achieve construction space and component savings in the proposed double clutch transmission. In particular, fixed gears of dual gear planes can be divided into two fixed gears for two single gear planes. In this way, step changes can be improved. In addition, it is possible to exchange the countershafts. The subtransmissions can also be exchanged, which is to say mirrored about a vertical axis. In the process, the hollow shaft and solid shaft are exchanged. In this way it is possible, for example, to dispose the smallest gear wheel on the solid shaft in order to further optimize the use of the available construction space. In addition, adjacent gear planes can be exchanged, for example, in order to optimize shaft deflection and/or to optimally link a shift actuating system. In addition, the respective arrangement positions of the coupling devices on the gear plane can be varied. Furthermore, the effective direction of the coupling device can be varied.

The gear numbers used in the present invention were freely defined. It is also possible to add a crawler gear and/or an overdrive gear in order to improve the off-road handling characteristics or the acceleration behavior of a vehicle. In addition, a first gear can be eliminated so as to better optimize the step changes as a whole. The gear numbers vary accordingly with these measures.

Independent of the respective variant embodiments of the double clutch transmission, it is also possible to preferably not arrange the drive shaft and the output shaft coaxially to one another, which results in a particularly space-saving arrangement. For example, the shafts thereby arranged spatially behind one another can also be slightly offset from one another. In this arrangement, a direct gear having a transmission ratio of one can be implemented by way of gear meshing and can advantageously be placed relatively freely on the sixth to ninth gears. Other arrangement possibilities of the drive shaft and the output shaft are also conceivable.

The proposed double clutch transmission is preferably equipped with an integrated output stage. The output stage may comprise a fixed gear on the output shaft as the output gear, which meshes with a first output gear as the constant pinion of the first countershaft and with a second output gear as the constant pinion of the second countershaft. Optionally, both output gears can be designed as shiftable gears. In order to shift the respective output gear, a winding path gear coupling device may be associated which in the disengaged state releases the connection between the associated countershaft and the output gear in order to shift winding path gears.

Advantageously, the lower forward gears and the reverse gears can be actuated by a start-up or shifting clutch in order to focus higher loads on this clutch and thereby be able to implement the second clutch in a more space-saving and cost-effective manner. In particular, the gear planes can be arranged in the proposed double clutch transmission such that starting can be carried both by way of the inner transmission input shaft or the outer transmission input shaft, and therefore by way of the clutch that is better suited, which is also possible for a concentrically arranged, radially nested construction of the double clutch. For this purpose, the gear planes can be arranged and/or exchanged accordingly mirror-symmetrically.

Independent of the respective variant embodiment, the provided gear planes can be exchanged in the double clutch transmission for example.

### BRIEF DESCRIPTION OF THE DRAWINGS

The present invention will be explained in more detail hereinafter with reference to the figures, wherein:

FIG. 1 is a schematic illustration of a 1st variant embodiment of an eight-speed double clutch transmission according to the invention;

FIG. 2 is a shift pattern of the 1st variant embodiment according to FIG. 1;

FIG. 3 is a schematic illustration of a 2nd variant embodiment of the eight-speed double clutch transmission according to the invention;

FIG. 4 is a shift pattern of the 2nd variant embodiment according to FIG. 3;

FIG. 5 is a schematic illustration of a 3rd variant embodiment of the eight-speed double clutch transmission according to the invention;

FIG. 6 is a shift pattern of the 3rd variant embodiment according to FIG. 5;

FIG. 7 is a schematic illustration of a 4th variant embodiment of the eight-speed double clutch transmission according to the invention;

FIG. 8 is a shift pattern of the 4th variant embodiment according to FIG. 7;

FIG. 9 is a schematic illustration of a 5th variant embodiment of the eight-speed double clutch transmission according to the invention;

FIG. 10 is a shift pattern of the 5th variant embodiment according to FIG. 9;

FIG. 11 is a schematic illustration of a 6th variant embodiment of the eight-speed double clutch transmission according to the invention;

FIG. 12 is a shift pattern of the 6th variant embodiment according to FIG. 11;

FIG. 13 is a schematic illustration of a 7th variant embodiment of the eight-speed double clutch transmission according to the invention;

FIG. 14 is a shift pattern of the 7th variant embodiment according to FIG. 13;

FIG. 15 is a schematic illustration of a 8th variant embodiment of the eight-speed double clutch transmission according to the invention;

FIG. 16 is a shift pattern of the 8th variant embodiment according to FIG. 15;

FIG. 17 is a schematic illustration of a 9th variant embodiment of the eight-speed double clutch transmission according to the invention;

FIG. 18 is a shift pattern of the 9th variant embodiment according to FIG. 17;

FIG. 19 is a schematic illustration of a 10th variant embodiment of the eight-speed double clutch transmission according to the invention;

FIG. 20 is a shift pattern of the 10th variant embodiment according to FIG. 19;

FIG. 21 is a schematic illustration of a 11th variant embodiment of the eight-speed double clutch transmission according to the invention; and

FIG. 22 is a shift pattern of the 11th variant embodiment according to FIG. 21.

### DETAILED DESCRIPTION OF THE PREFERRED EMBODIMENTS

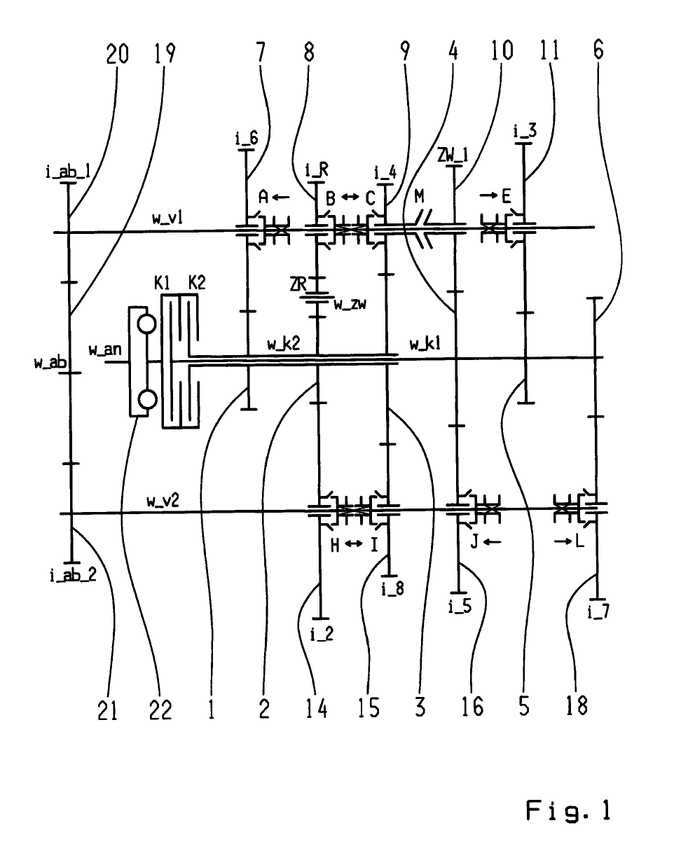

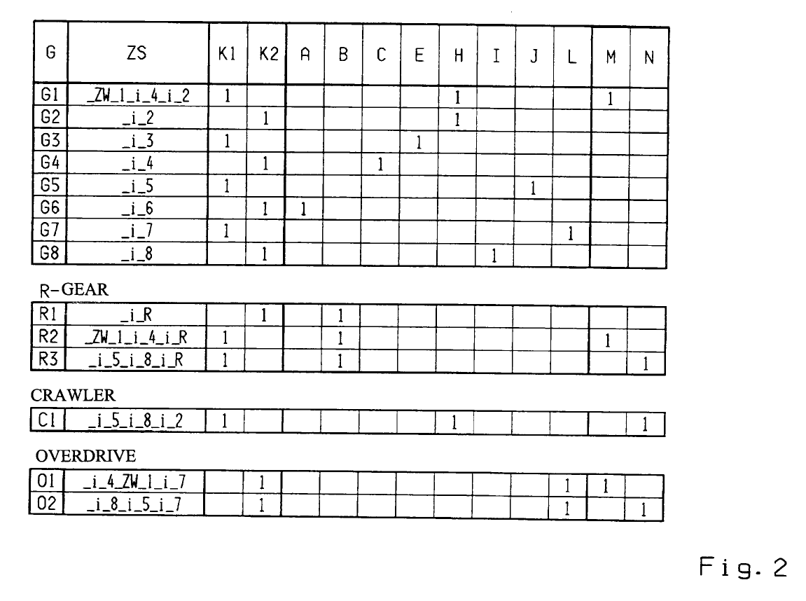

FIGS. 1, 3, 5, 7, 9, 11, 13, 15, 17, 19, and 21 each show a possible variant embodiment of an eight-speed double clutch transmission. The corresponding shift patterns for the different variant embodiments are illustrated in tabular form in FIGS. 2, 4, 6, 8, 10, 12, 14, 16, 18, 20, and 22.

The eight-speed double clutch transmission comprises two clutches K1, K2, the input sides of which are connected to a drive shaft w_an and the output sides of which are respectively connected to one of two transmission input shafts w_k1, w_k2, which are arranged coaxially to one another. In addition, a torsion vibration damper 22 can be arranged on the drive shaft w_an. Furthermore, two countershafts w_v1, w_v2 are provided, on which toothed gearwheels designed as idler gears 7, 8, 9, 10, 11, 12, 13, 14, 15, 16, 17, 18 are rotatably mounted. The two transmission input shafts w_k1, w_k2 are provided with toothed gearwheels, which are arranged in a rotationally fixed manner and designed as fixed gears 1, 2, 3, 4, 5, 6, and at least some of which mesh with the idler gears 7, 8, 9, 10, 11, 12, 13, 14, 15, 16, 17, 18.

In order to connect the idler gears 7, 8, 9, 10, 11, 12, 13, 14, 15, 16, 17, 18 to the respective countershaft w_v1, w_v2, a plurality of activatable coupling devices A, B, C, E, D, F, G, H, I, J, K, L are provided on the countershafts w_v1, w_v2. Furthermore, output gears 20, 21 are disposed as constant pinions on the two countershafts w_v1, w_v2, the output gears being coupled, in each case, to gearing of a fixed gear 19 of an output shaft w_ab, wherein the output gears 20, 21 are associated with the corresponding output stages i_ab_1, i_ab_2.

In addition to the coupling devices A, B, C, D, E, F, G, H, I, K, L, which in the activated state implement a rotationally fixed connection between a toothed gearwheel and the associated countershaft w_v1, w_v2, a winding path gear shift element M is provided on the first countershaft w_v1, w_v2.

The shift element M is used to connect the idler gears 9 and 10 of the first countershaft w_v1 to one another in order to couple the first subtransmission to the second subtransmission such that the winding path gears can be shifted. The shift element N can optionally be used to connect the idler gears 15 and 16 of the second countershaft w_v2 to one another, in order to couple the first subtransmission to the second subtransmission such that the winding path gears can be shifted.

According to the invention, the double clutch transmission is provided with six gear planes 7-1, 1-13, 7-13, 8-2, 2-14, 8-14, 9-15, 10-16, 11-5, 11-17, 12-6, 6-18, wherein in each variant embodiment three dual gear planes 7-13, 8-14, 9-15, 10-16, 11-17 and three single gear planes 1-13, 7-1, 8-2, 2-14, 11-5, 6-18, 12-6 are provided, so that winding path gears can be shifted at least with the shift element M being activated. A claw or the like, for example, can be used as the shift element M or N for connecting two gears or the like.

In the first and second variant embodiments according to FIGS. 1 to 4, with the first gear plane 7-1 designed as a single gear plane, the fixed gear 1 of the second transmission input shaft w_k2 meshes only with the idler gear 7 of the first countershaft w_v1. In the second gear plane 8-14 designed as a dual gear plane, the fixed gear 2 of the second transmission input shaft w_k2 meshes with both the idler gear 14 of the second countershaft w_v2 and an intermediate gear ZR on an intermediate shaft w_zw for the purpose of rotation reversal for the reverse gear transmission ratios, wherein the intermediate gear ZR also meshes with the idler gear 8 of the first countershaft w_v1. With the third gear plane 9-15 designed as a dual gear plane, the fixed gear 3 of the second transmission input shaft w_k2 meshes with both the idler gear 9 of the first countershaft w_v1 and with the idler gear 15 of the second countershaft w_v2. With the fourth gear plane 10-16 designed as a dual gear plane, the fixed gear 4 of the first transmission input shaft w_k1 meshes with both the idler gear 10 of the first countershaft w_v1 and with the idler gear 16 of the second countershaft w_v2. In the fifth gear plane 11-5 designed as a single gear plane, the fixed gear 5 of the first transmission input shaft w_k1 meshes with the idler gear 11 of the first countershaft w_v1. In the sixth gear plane 6-18 designed as the single gear plane, the fixed gear 6 of the first transmission input shaft w_k1 meshes with the idler gear 18 of the second countershaft w_v2.

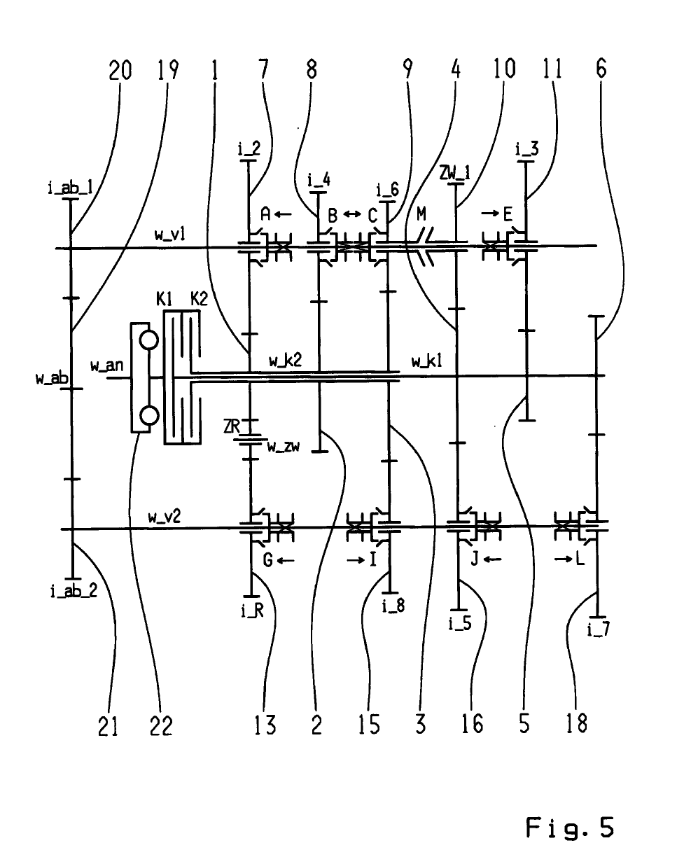

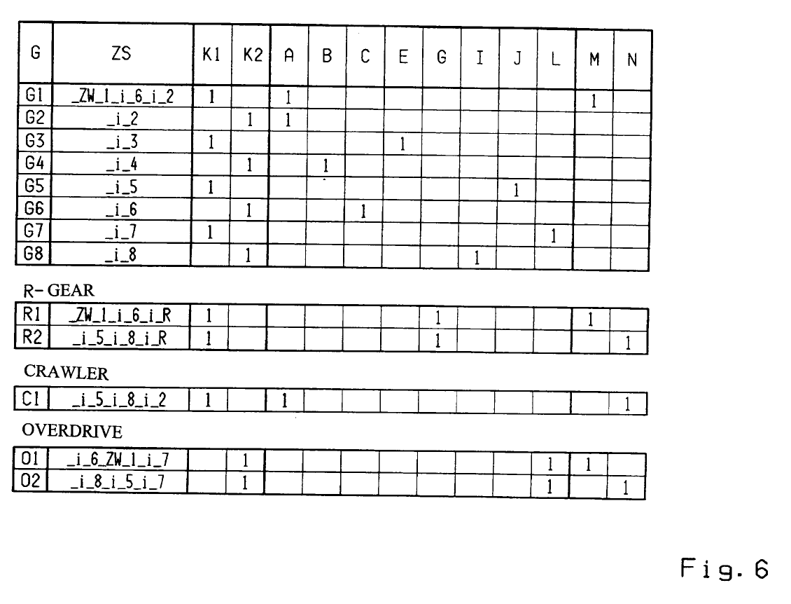

In the third variant embodiment according to FIGS. 5 and 6, in the first gear plane 7-13 designed as a dual gear plane, the fixed gear 1 of the second transmission input shaft w_k2 meshes with both the idler gear 7 of the first countershaft w_v1 and with the intermediate gear ZR for the purpose of rotation reversal for the reverse gear transmission ratios, wherein the intermediate gear ZR also meshes with the idler gear 13 of the second countershaft w_v2. In the second gear plane 8-2 designed as a single gear plane, the fixed gear 2 of the second transmission input shaft w_v2 meshes with the idler gear 8 of the first countershaft w_v1. In the third gear plane 9-15 designed as a dual gear plane, the fixed gear 3 of the second transmission input shaft w_k2 meshes with both the idler gear 9 of the first countershaft w_v1 and with the idler gear 15 of the second countershaft w_v2. In the fourth gear plane 10-16 designed as a dual gear plane, the fixed gear 4 of the first transmission input shaft w_k1 meshes with the idler gear 10 of the first countershaft w_v1 and with the idler gear 16 of the second countershaft w_v2. In the fifth gear plane 11-5 designed as a single gear plane, the fixed gear 5 of the first transmission input shaft w_k1 meshes with the idler gear 11 of the first countershaft w_v1. Finally, in the sixth gear plane 6-18 designed as a single gear plane, the fixed gear 6 of the first transmission input shaft w_k1 meshes with the idler gear 18 of the second countershaft w_v2.

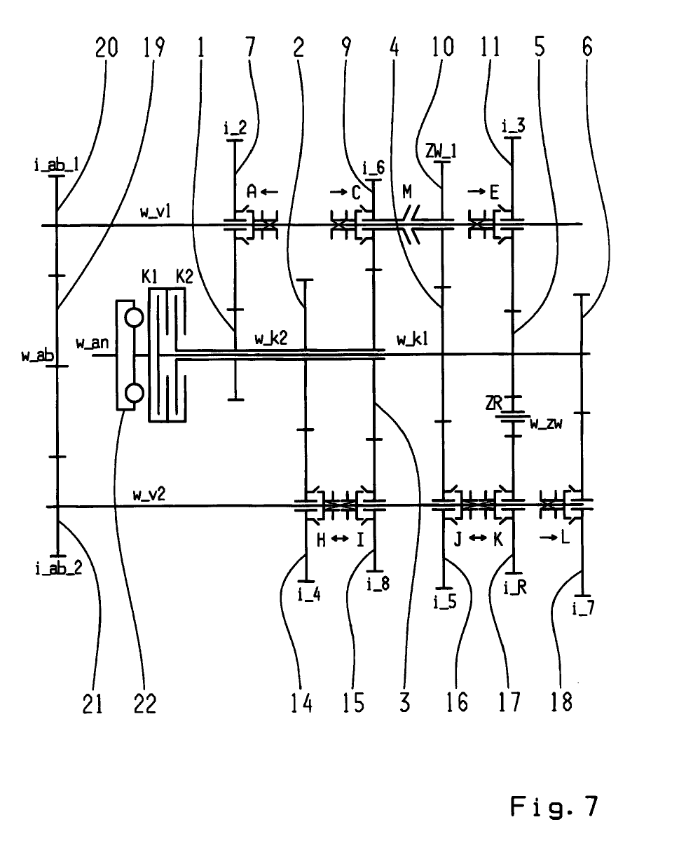

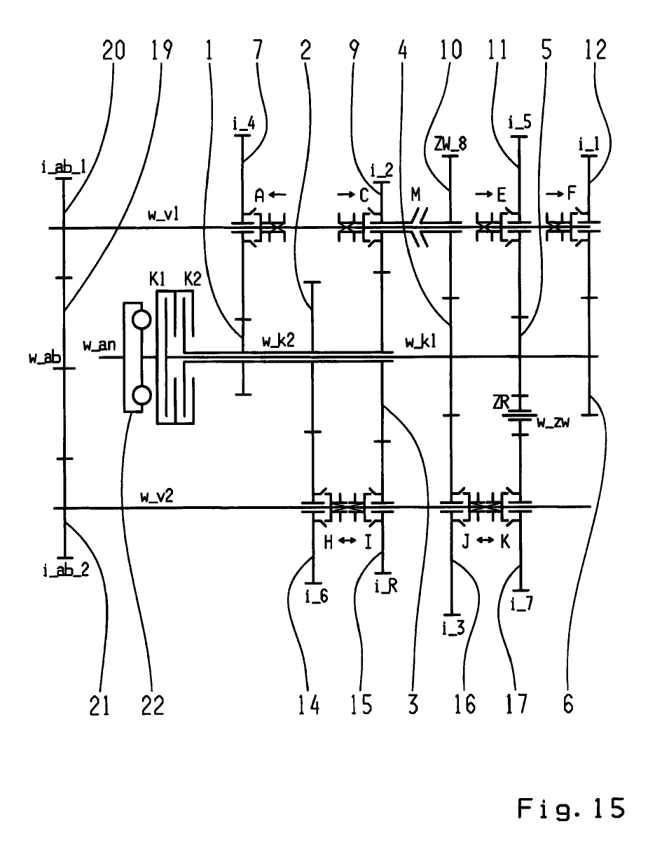

In the fourth and eighth variant embodiments according to FIGS. 7 and 15, in the first gear plane 7-1 designed as a single gear plane, the fixed gear 1 of the second transmission input shaft w_k2 meshes with the idler gear 7 of the first countershaft w_v1. In the second gear plane 2-14 designed as a single gear plane, the fixed gear 2 of the second transmission input shaft w_k2 meshes with the idler gear 14 of the second countershaft w_v2. With the third gear plane 9-15 designed as a dual gear plane, the fixed gear 3 of the second transmission input shaft w_k2 meshes with both the idler gear 9 of the first countershaft w_v1 and with the idler gear 15 of the second countershaft w_v2. With the fourth gear plane 10-16 designed as a dual gear plane, the fixed gear 4 of the first transmission input shaft w_k1 meshes with both the idler gear 10 of the first countershaft w_v1 and with the idler gear 16 of the second countershaft w_v2. With the fifth gear plane 11-17 designed as a dual gear plane, the fixed gear 5 of the first transmission input shaft w_k1 meshes with both the idler gear 11 of the first countershaft w_v1 and with the intermediate gear ZR for the purpose of rotation reversal for the reverse gear transmission ratios, wherein the intermediate gear ZR also meshes with the idler gear 17 of the second countershaft w_v2. In the fourth variant embodiment, in the sixth gear plane 6-18 designed as the single gear plane, the fixed gear 6 of the first transmission input shaft w_k1 meshes with the idler gear 18 of the second countershaft w_v2. In contrast, in the eighth variant embodiment, in the sixth gear plane 12-6 designed as a single gear plane, the fixed gear 6 meshes with the idler gear 12 of the first countershaft w_v1.

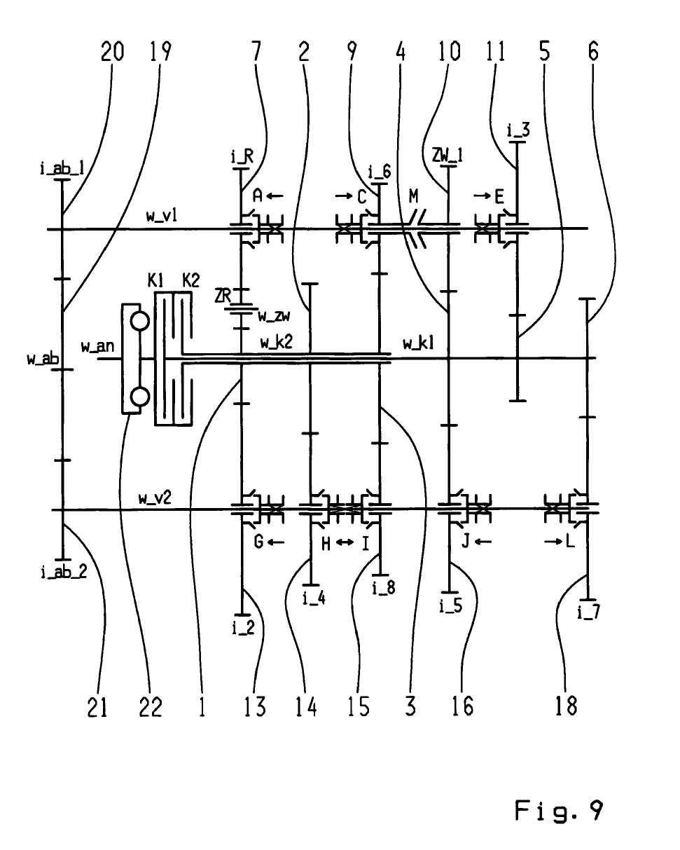

In the fifth and sixth variant embodiments according to FIGS. 9 to 12, in the first gear plane 7-13 designed as a dual gear plane, the fixed gear 1 of the second transmission input shaft w_k2 meshes with both the idler gear 13 of the second countershaft w_v2 and with the intermediate gear ZR for the purpose of rotation reversal for the reverse gear transmission ratios, wherein the intermediate gear ZR also meshes with the idler gear 7 of the first countershaft w_v1. In the second gear plane 2-14 designed as a single gear plane, the fixed gear 2 of the second transmission input shaft w_k2 meshes with the idler gear 14 of the second countershaft w_v2. With the third gear plane 9-15 designed as a dual gear plane, the fixed gear 3 of the second transmission input shaft w_k2 meshes with both the idler gear 15 of the second countershaft w_v2 and with the idler gear 9 of the first countershaft w_v1. In the fourth gear plane 10-16 designed as a dual gear plane, the fixed gear 4 of the first transmission input shaft w_k1 meshes with both the idler gear 10 of the first countershaft w_v1 and with the idler gear 16 of the second countershaft w_v2. With the fifth gear plane 11-5 designed as the single gear plane, the fixed gear 5 of the first transmission input shaft w_k1 meshes with the idler gear 11 of the first countershaft w_v1. Finally, in the sixth gear plane 6-18 designed as a single gear plane, the fixed gear 6 of the first transmission input shaft w_k1 meshes with the idler gear 18 of the second countershaft w_v2.

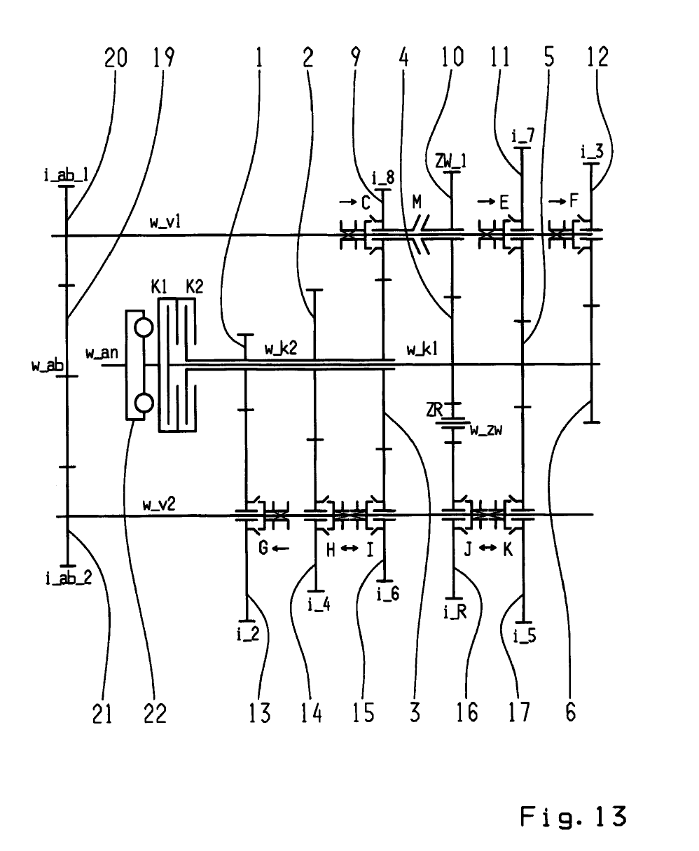

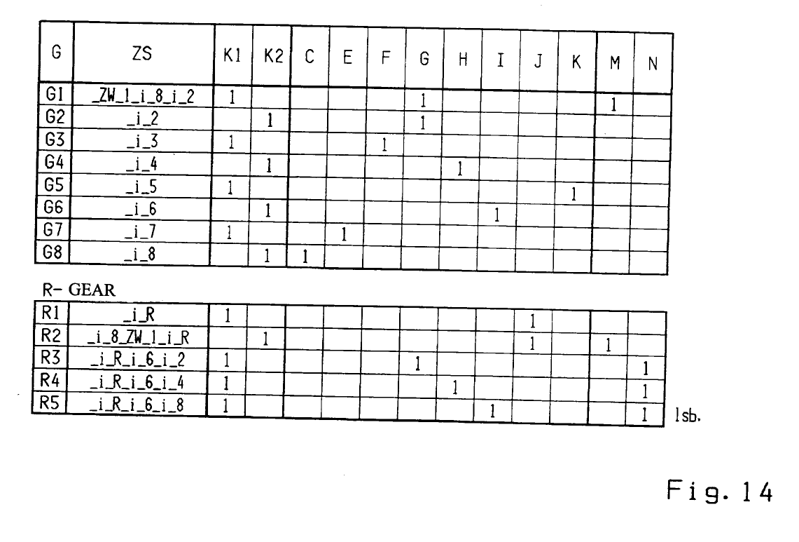

In the seventh variant embodiment according to FIGS. 13 and 14, in the first gear plane 1-13 designed as a single gear plane, the fixed gear 1 of the second transmission input shaft w_k2 meshes with the idler gear 13 of the second countershaft w_v2. With the second gear plane 2-14 designed as a single gear plane, the fixed gear 2 of the second transmission input shaft w_k2 meshes with the idler gear 14 of the second countershaft w_v2. In the third gear plane 9-15 designed as a dual gear plane, the fixed gear 3 of the second transmission input shaft w_k2 meshes with both the idler gear 9 of the first countershaft w_v1 and with the idler gear 15 of the second countershaft w_v2. With the fourth gear plane 10-16 designed as a dual gear plane, the fixed gear 4 of the first transmission input shaft w_k1 meshes with both the idler gear 10 of the first countershaft w_v1 and with the intermediate gear ZR for the purpose of rotation reversal for the reverse gear transmission ratios, wherein the intermediate gear ZR also meshes with the idler gear 16 of the second countershaft w_v2. With the fifth gear plane 11-17 designed as a dual gear plane, the fixed gear 5 of the first transmission input shaft w_k1 meshes with both the idler gear 11 of the first countershaft w_v1 and with the idler gear 17 of the second countershaft w_v2. Finally, in the sixth gear plane 12-6 designed as a single gear plane, the fixed gear 6 of the first transmission input shaft w_k1 meshes with the idler gear 12 of the first countershaft w_v1.

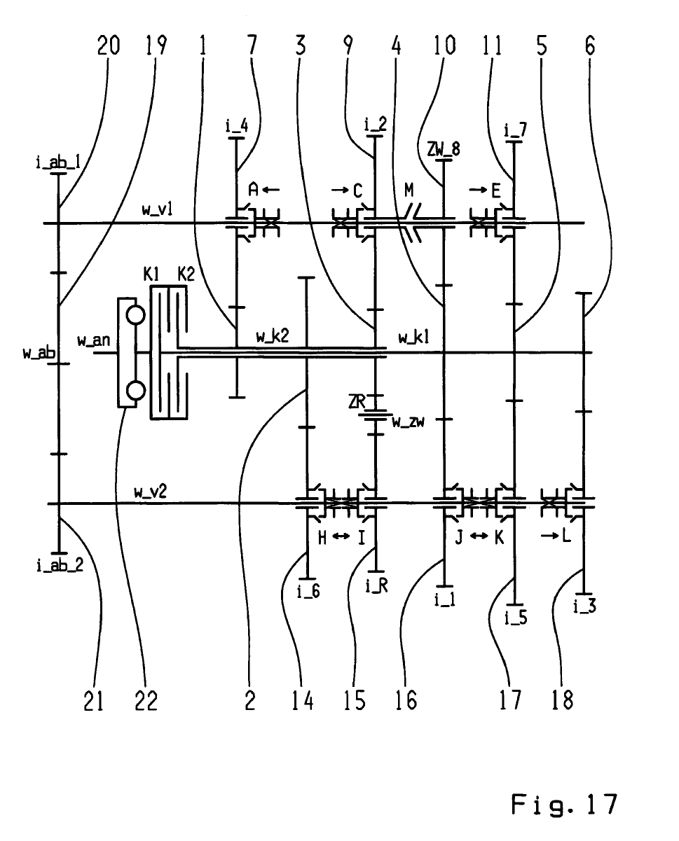

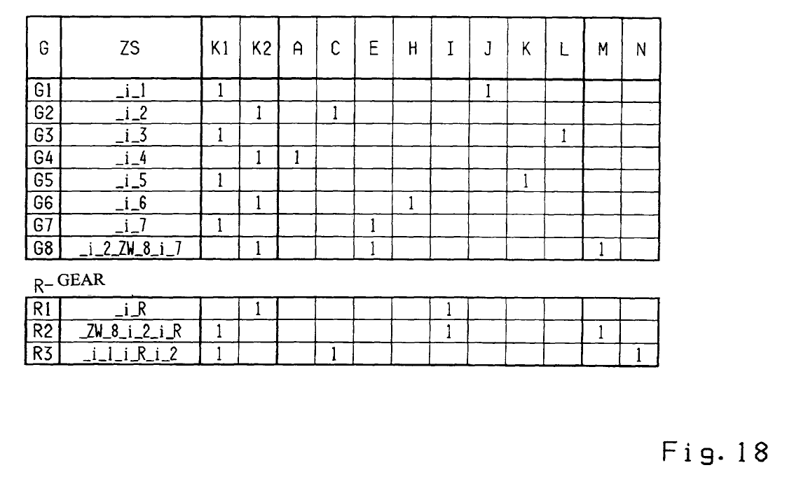

In the ninth variant embodiment according to FIGS. 17 and 18, in the first gear plane 7-1 designed as a single gear plane, the fixed gear 1 of the second transmission input shaft w_k2 meshes with the idler gear 7 of the first countershaft w_v1. With the second gear plane 2-14 designed as a single gear plane, the fixed gear 2 of the second transmission input shaft w_k2 meshes with the idler gear 14 of the second countershaft w_v2. With the third gear plane 9-15 designed as a dual gear plane, the fixed gear 3 of the second transmission input shaft w_k2 meshes with both the idler gear 9 of the first countershaft w_v1 and with the intermediate gear ZR for the purpose of rotation reversal for the reverse gear transmission ratios, wherein the intermediate gear ZR also meshes with the idler gear 15 of the second countershaft w_v2. With the fourth gear plane 10-16 designed as a dual gear plane, the fixed gear 4 of the first transmission input shaft w_k1 meshes with both the idler gear 10 of the first countershaft w_v1 and with the idler gear 16 of the second countershaft w_v2. With the fifth gear plane 11-17 designed as a dual gear plane, the fixed gear 5 of the first transmission input shaft w_k1 meshes with both the idler gear 11 of the first countershaft w_v1 and with the idler gear 17 of the second countershaft w_v2. Finally, in the sixth gear plane 6-18 designed as a single gear plane, the fixed gear 6 of the first transmission input shaft w_k1 meshes with the idler gear 18 of the second countershaft w_v2.

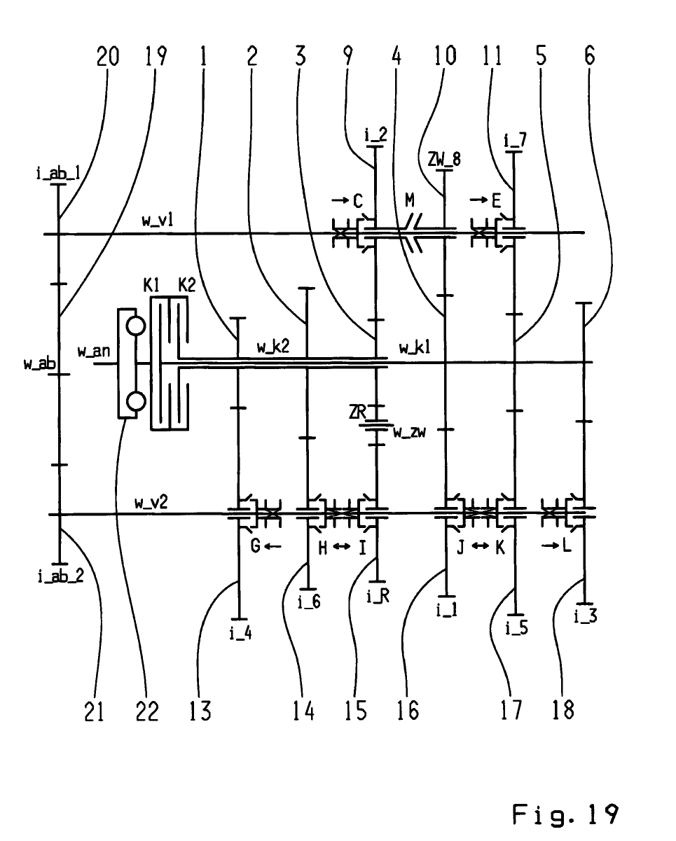

In the 10th and 11th variant embodiments according to FIGS. 19 to 22, in the first gear plane 1-13 designed as a single gear plane, the fixed gear 1 of the second transmission input shaft w_k2 meshes with the idler gear 13 of the second countershaft w_v2. With the second gear plane 2-14 designed as a single gear plane, the fixed gear 2 of the second transmission input shaft w_k2 meshes with the idler gear 14 of the second countershaft w_v2. With the third gear plane 9-15 designed as a dual gear plane, the fixed gear 3 of the second transmission input shaft w_k2 meshes with both the idler gear 9 of the first countershaft w_v1 and with the intermediate gear ZR for the purpose of rotation reversal for the reverse gear transmission ratios, wherein the intermediate gear ZR also meshes with the idler gear 15 of the second countershaft w_v2. With the fourth gear plane 10-16 designed as a dual gear plane, the fixed gear 4 of the first transmission input shaft w_k1 meshes with both the idler gear 10 of the first countershaft w_v1 and with the idler gear 16 of the second countershaft w_v2. With the fifth gear plane 11-17 designed as a dual gear plane, the fixed gear 5 of the first transmission input shaft w_k1 meshes with both the idler gear 11 of the first countershaft w_v1 and with the idler gear 17 of the second countershaft w_v2. Finally, in the 10th variant embodiment, with the sixth gear plane 6-18 designed as the single gear plane, the fixed gear 6 of the first transmission input shaft w_k1 meshes with the idler gear 18 of the second countershaft w_v2. In the 11th variant embodiment, the fixed gear 6 in the sixth gear plane 12-6 meshes with the idler gear 12 of the first countershaft w_v1.

In the first and second variant embodiments according to FIGS. 1 to 4, one dual acting coupling device B-C and two single acting coupling devices A and E are provided on the first countershaft w_v1, which are disposed such that the activated coupling device A rigidly connects the idler gear 7, the activated coupling device B rigidly connects the idler gear 8, the activated coupling device C rigidly connects the idler gear 9, and the activated coupling device E rigidly connects the idler gear 11 to the first countershaft w_v1. Furthermore, one dual acting coupling device H-I and two single acting coupling devices J and L are provided on the second countershaft w_v2, which are arranged such that the activated coupling device H rigidly connects the idler gear 14, the activated coupling devices I rigidly connects the idler gear 15, the activated coupling device J rigidly connects the idler gear 16, and the activated coupling device L rigidly connects the idler gear 18 to the second countershaft w_v2. In contrast, in the third variant embodiment according to FIG. 5, four single acting coupling devices G, I, J and L are provided at the second countershaft w_v2, which are arranged such that the activated coupling device G rigidly connects the idler gear 13, the activated coupling device I rigidly connects the idler gear 15, the activated coupling device J rigidly connects the idler gear 16, and the activated coupling device L rigidly connects the idler gear 18 to the second countershaft w_v2.

In the third variant embodiment according to FIGS. 5 and 6, one dual acting coupling device B-C and two single acting coupling devices A and E are provided on the first countershaft w_v1, which are disposed such that the activated coupling device A rigidly connects the idler gear 7, the activated coupling device B rigidly connects the idler gear 8, the activated coupling device C rigidly connects the idler gear 9, and the activated coupling device E rigidly connects the idler gear 11 to the first countershaft w_v1. Four single acting coupling devices G, I, J and L are provided on the second countershaft w_v2, which are arranged such that the activated coupling device G rigidly connects the idler gear 13, the activated coupling devices I rigidly connects the idler gear 15, the activated coupling device J rigidly connects the idler gear 16, and the activated coupling device L rigidly connects the idler gear 18 to the second countershaft w_v2.

In the fourth, seventh, ninth, and eleventh variant embodiments according to FIGS. 7, 13, 17, and 21, three single acting coupling devices A, C and E, or C, E and F are provided on the first countershaft, which are disposed such that the activated coupling device A rigidly connects the idler gear 7, the activated coupling device C rigidly connects the idler gear 9, the activated coupling device E rigidly connects the idler gear 11, and the activated coupling device F rigidly connects the idler gear 12 to the first countershaft w_v1. Two dual acting coupling devices H-I and J-K and one single acting coupling device G or L are provided on the second countershaft w_v2, which are disposed such that the activated coupling device G rigidly connects the idler gear 13, the activated coupling device H rigidly connects the idler gear 14, the activated coupling device I rigidly connects the idler gear 15, and the activated coupling device J rigidly connects the idler gear 16, the activated coupling device K rigidly connects the idler gear 17, and the activated coupling device L rigidly connects the idler gear 18 to the second countershaft w_v2.

In the fifth and sixth variant embodiments according to FIGS. 9 to 12, three single acting coupling devices A, C, and E are provided on the first countershaft w_v1, which are disposed such that the activated coupling device A rigidly connects the idler gear 7, the activated coupling device C rigidly connects the idler gear 9, and the activated coupling device E rigidly connects the idler gear 11 to the first countershaft w_v1. One dual acting coupling device H-I and three single acting coupling devices G, J, and L are provided on the second countershaft, which are disposed such that the activated coupling device G rigidly connects the idler gear 13, the activated coupling device H rigidly connects the idler gear 14, the activated coupling device I rigidly connects the idler gear 15, the activated coupling device J rigidly connects the idler gear 16, and the activated coupling device L rigidly connects the idler gear 18 to the second countershaft w_v2.

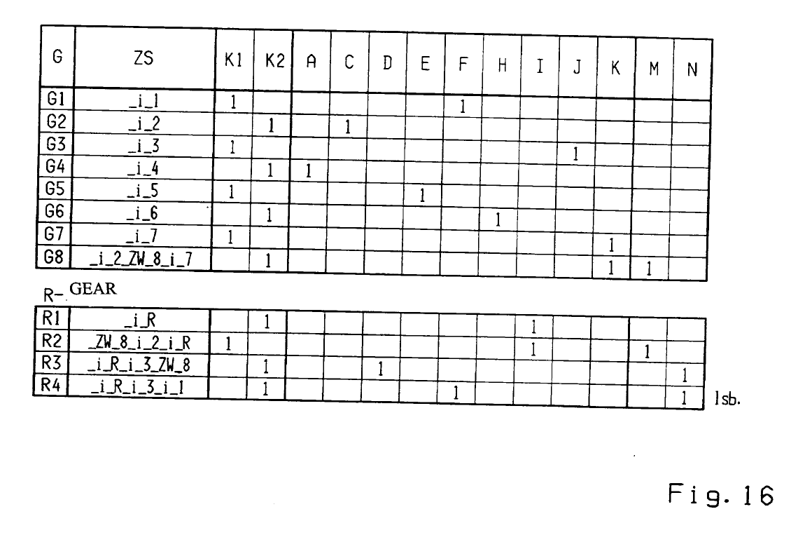

In the eighth variant embodiment according to FIGS. 15 and 16, four single acting coupling devices A, C, E, and F are provided on the first countershaft w_v1, which are disposed such that the activated coupling device A rigidly connects the idler gear 7, the activated coupling device C rigidly connects the idler gear 9, the activated coupling device E rigidly connects the idler gear 11, and the activated coupling device F rigidly connects the idler gear 12 to the first countershaft w_v1. Two dual acting coupling devices H-I and J-K are provided on the second countershaft w_v2, which are disposed such that the activated coupling device H rigidly connects the idler gear 14, the activated coupling device I rigidly connects the idler gear 15, the activated coupling device J rigidly connects the idler gear 16, and the activated coupling device K rigidly connects the idler gear 17 to the second countershaft w_v2.

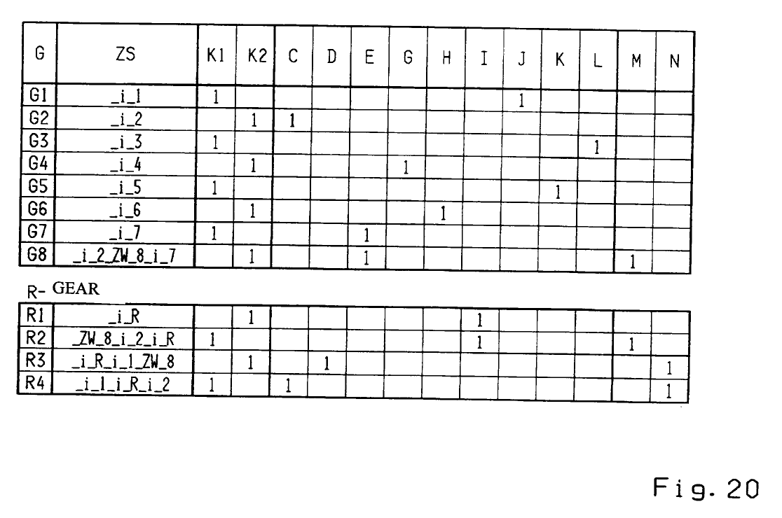

In the 10th variant embodiment according to FIGS. 19 and 20, two single acting coupling devices C and E are provided on the countershaft w_v1, which are disposed such that the activated coupling device C rigidly connects the idler gear 9 and the activated coupling device E rigidly connects the idler gear 11 to the first countershaft w_v1. Two dual acting coupling devices H-I and J-K and two single acting coupling devices G and L are provided on the second countershaft w_v2, which are disposed such that the activated coupling device G rigidly connects the idler gear 13, the activated coupling device H rigidly connects the idler gear 14, the activated coupling device I rigidly connects the idler gear 15, the activated coupling device J rigidly connects the idler gear 16, the activated coupling device K rigidly connects the idler gear 17, and the activated coupling device L rigidly connects the idler gear 18 to the second countershaft w_v2.

Independent of the respective variant embodiments, the double clutch transmission according to the invention is provided with an integrated output stage having the output gear 20 and the output gear 21. The output gear 20 and the output gear 21 each mesh with a fixed gear 19 of the output shaft w_ab. Optionally, shiftable connections can be implemented between the output gears 20, 21 and the associated countershafts w_v1, w_v2 by shiftable coupling devices S_ab1, S_ab2, which are not illustrated in detail in the figures.

Furthermore, in the double clutch transmission according to the invention at least the forward gears G1 to G8 are designed to be power shiftable. Depending on the variant embodiment, additionally at least one reverse gear and/or crawler gears and/or overdrive gears can be implemented in a power shiftable manner as winding path gears. Details for each variant embodiment will be apparent from the shift patterns described hereinafter.

The table illustrated in FIG. 2 shows, by way of example, a shift pattern for the 1st variant embodiment of the eight-speed double clutch transmission according to FIG. 1

From the shift pattern it is apparent, that the first forward gear G1 can be shifted by the first clutch K1 and by the activated coupling device H, and as a winding path gear by the activated shift element M, the second forward gear G2 can be shifted by the second clutch K2 and by the activated coupling device H, the third forward gear G3 can be shifted by the first clutch K1 and by the activated coupling device E, the fourth forward gear G4 can be shifted by the second clutch K2 and by the activated coupling device C, the fifth forward gear G5 can be shifted by the first clutch K1 and the activated coupling device J, the sixth forward gear G6 can be shifted by the second clutch K2 and by the activated coupling device A, the seventh forward gear G7 can be shifted by the first clutch K1 and the activated coupling device L, and the eighth forward gear G8 can be shifted by the second clutch K2 and the activated coupling device I. In this way, at least the first eight forward gears can be implemented as power shiftable (Isb.)

Furthermore, a reverse gear R1 can be shifted by the second clutch K2 and by the activated coupling device B. A reverse gear R2 can be shifted by the first clutch K1 and by the activated coupling device B, and as a winding path gear with the shift element M being activated. Furthermore, a reverse gear R3 can be shifted by the first clutch K1 and by the activated coupling device B, and as a winding path gear with the shift element N being activated.

In addition, it is apparent from the shift pattern according to FIG. 2 that a crawler gear C1 can be shifted by the first clutch K1 and by the activated coupling device H, and as a winding path gear with the shift element N being activated.

Finally, an overdrive gear O1 can be shifted by the second clutch K2 and by the activated coupling device L, and as a winding path gear with the shift element M being activated. An overdrive gear O2 can be shifted by the second clutch K2 and by the activated coupling device L, and as a winding path gear with the shift element N being activated.

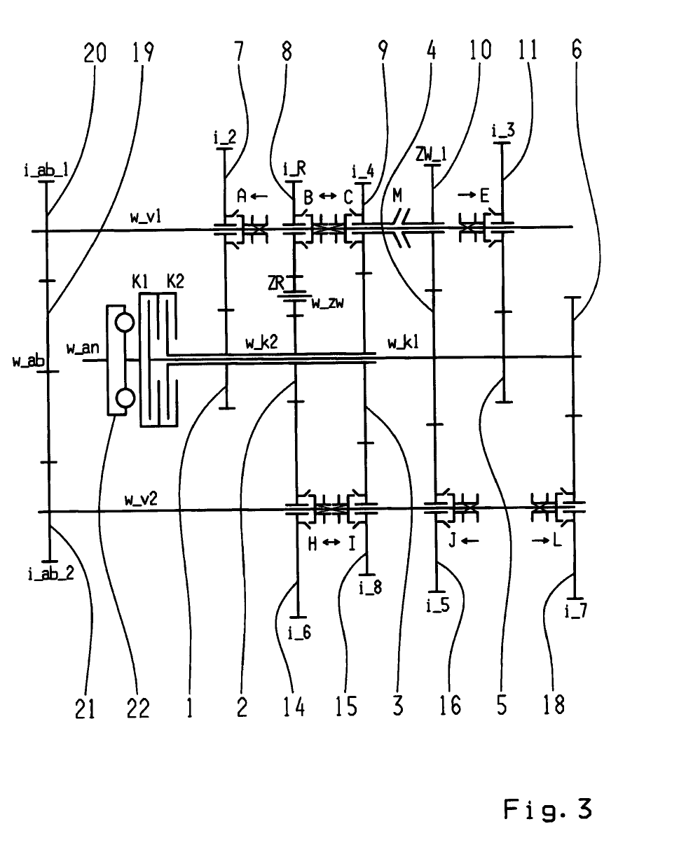

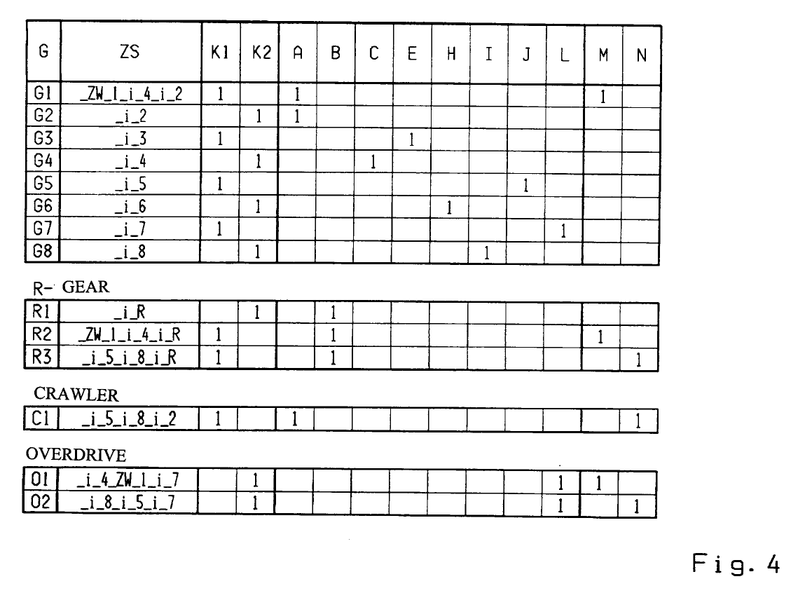

The table illustrated in FIG. 4 shows, by way of example, a shift pattern for the 2nd variant embodiment of the eight-speed double clutch transmission according to FIG. 3.

From the shift pattern, it is apparent that the first forward gear G1 can be shifted by the first clutch K1 and by the activated coupling device A, and as a winding path gear with the shift element M being activated, the second forward gear G2 can be shifted by the second clutch K2 and by the activated coupling device A, the third forward gear G3 can be shifted by the first clutch K1 and by the activated coupling device E, the fourth forward gear G4 can be shifted by the second clutch K2 and by the activated coupling device C, the fifth forward gear G5 can be shifted by the first clutch K1 and by the activated coupling device J, the sixth forward gear G6 can be shifted by the second clutch K2 and by the activated coupling device H, the seventh forward gear G7 can be shifted by the first clutch K1 and by the activated coupling device L, and the eighth forward gear G8 can be shifted by the second clutch K2 and by the activated coupling device I. In this way, at least the first eight forward gears can be implemented as power shiftable (Isb.)

Furthermore, for example, a reverse gear R1 can be shifted by the second clutch K2 and by the activated coupling device B. A reverse gear R2 can be shifted by the first clutch K1 and by the activated coupling device B, and as a winding path gear with the shift element M being activated. Furthermore, a reverse gear R3 can be shifted by the first clutch K1 and by the activated coupling device B, and as a winding path gear with the shift element N being activated.

In addition, it is apparent from the shift pattern according to FIG. 4 that a crawler gear C1 can be shifted by the first clutch K1 and by the activated coupling device A, and as a winding path gear with the shift element N being activated.

Finally, an overdrive gear O1 can be shifted by the second clutch K2 and by the activated coupling device L, and as a winding path gear with the shift element M being activated. An overdrive gear O2 can be shifted by the second clutch K2 and by the activated coupling device L, and as a winding path gear with the shift element N being activated.

The table illustrated in FIG. 6 shows, by way of example, a shift pattern for the 3rd variant embodiment of the eight-speed double clutch transmission according to FIG. 5.

From the shift pattern, it is apparent that the first forward gear G1 can be shifted by the first clutch K1 and by the activated coupling device A, and as a winding path gear with the shift element M being activated, the second forward gear G2 can be shifted by the second clutch K2 and by the activated coupling device A, the third forward gear G3 can be shifted by the first clutch K1 and by the activated coupling device E, the fourth forward gear G4 can be shifted by the second clutch K2 and by the activated coupling device B, the fifth forward gear G5 can be shifted by the first clutch K1 and by the activated coupling device J, the sixth forward gear G6 can be shifted by the second clutch K2 and by the activated coupling device C, the seventh forward gear G7 can be shifted by the first clutch K1 and by the activated coupling device L, and the eighth forward gear G8 can be shifted by the second clutch K2 and by the activated coupling device I. In this way, at least the first eight forward gears can be implemented as power shiftable (Isb.)

In addition, a reverse gear R1 can be shifted, for example, by the first clutch K1 and by the activated coupling device G, and as a winding path gear with the shift element M being activated. A reverse gear R2 can be shifted by the first clutch K1 and by the activated coupling device G, and as a winding path gear with the shift element N being activated.

In addition, it is apparent from the shift pattern according to FIG. 6 that a crawler gear C1 can be shifted by the first clutch K1 and by the activated coupling device A, and as a winding path gear with the shift element N being activated.

Finally, an overdrive gear O1 can be shifted by the second clutch K2 and by the activated coupling device L, and as a winding path gear with the shift element M being activated. An overdrive gear O2 can be shifted by the second clutch K2 and by the activated coupling device L, and as a winding path gear with the shift element N being activated.

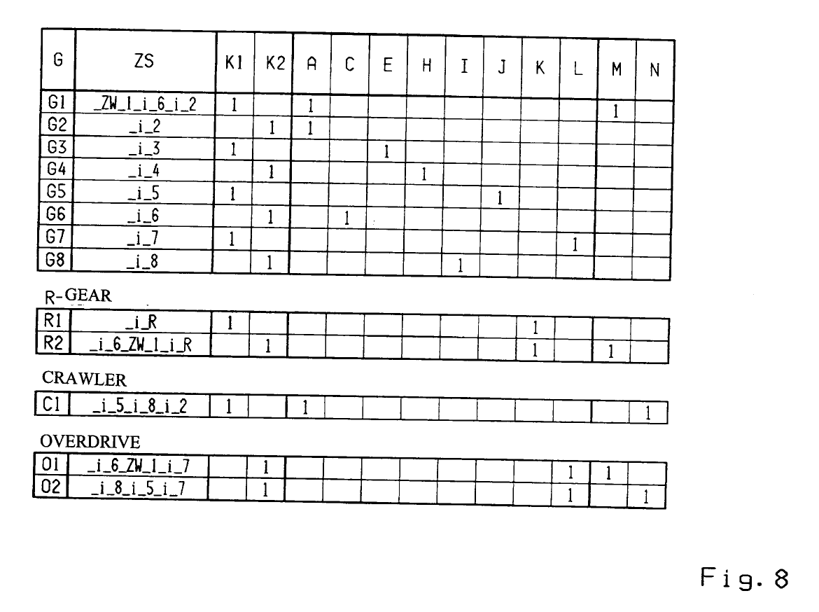

The table illustrated in FIG. 8 shows, by way of example, a shift pattern for the 4th variant embodiment of the eight-speed double clutch transmission according to FIG. 7.

From the shift pattern, it is apparent that the first forward gear G1 can be shifted by the first clutch K1 and by the activated coupling device A, and as a winding path gear with the shift element M being activated, the second forward gear G2 can be shifted by the second clutch K2 and by the activated coupling device A, the third forward gear G3 can be shifted by the first clutch K1 and by the activated coupling device E, the fourth forward gear G4 can be shifted by the second clutch K2 and by the activated coupling device H, the fifth forward gear G5 can be shifted by the first clutch K1 and by the activated coupling device J, the sixth forward gear G6 can be shifted by the second clutch K2 and by the activated coupling device C, the seventh forward gear G7 can be shifted by the first clutch K1 and by the activated coupling device L, and the eighth forward gear G8 can be shifted by the second clutch K2 and by the activated coupling device I. In this way, at least the first eight forward gears can be implemented as power shiftable (Isb.)

Furthermore, for example, a reverse gear R1 can be shifted by the first clutch K1 and by the activated coupling device K. A reverse gear R2 can be shifted by the second clutch K2 and by the activated coupling device K, and as a winding path gear with the shift element M being activated. In addition, it is apparent that a crawler gear C1 can be shifted by the first clutch K1 and by the activated coupling device A, and as a winding path gear with the shift element N being activated. Finally, an overdrive gear O1 can be shifted by the second clutch K2 and by the activated coupling device L, and as a winding path gear with the shift element M being activated. An overdrive gear O2 can be shifted by the second clutch K2 and by the activated coupling device L, and as a winding path gear with the shift element N being activated.

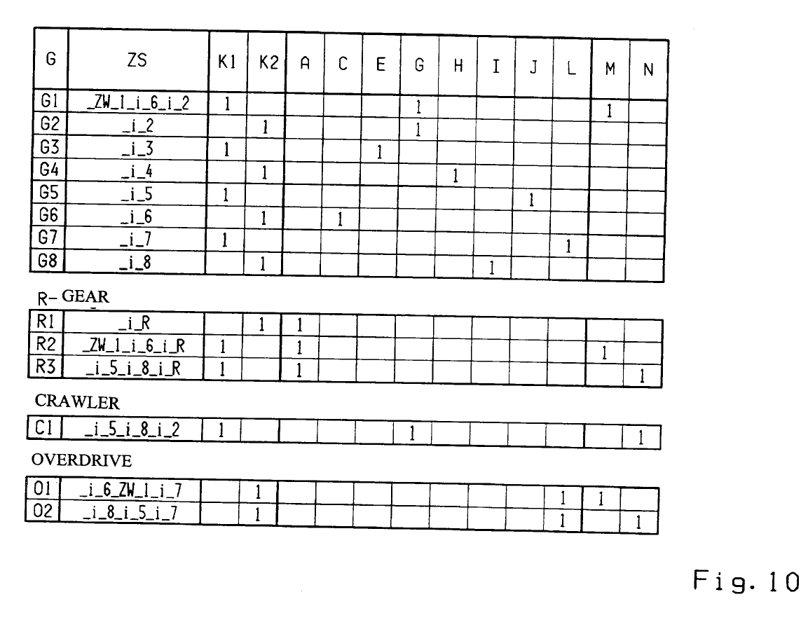

The table illustrated in FIG. 10 shows, by way of example, a shift pattern for the 5th variant embodiment of the eight-speed double clutch transmission according to FIG. 9.

From the shift pattern, it is apparent that the first forward gear G1 can be shifted by the first clutch K1 and by the activated coupling device G, and as a winding path gear with the shift element M being activated, the second forward gear G2 can be shifted by the second clutch K2 and by the activated coupling device G, the third forward gear G3 can be shifted by the first clutch K1 and by the activated coupling device E, the fourth forward gear G4 can be shifted by the second clutch K2 and by the activated coupling device H, the fifth forward gear G5 can be shifted by the first clutch K1 and by the activated coupling device J, the sixth forward gear G6 can be shifted by the second clutch K2 and by the activated coupling device C, the seventh forward gear G7 can be shifted by the first clutch K1 and by the activated coupling device L, and the eighth forward gear G8 can be shifted by the second clutch K2 and by the activated coupling device I. In this way, at least the first eight forward gears can be implemented as power shiftable (Isb.)

Furthermore, for example, a reverse gear R1 can be shifted by the second clutch K2 and by the activated coupling device A. A reverse gear R2 can be shifted by the first clutch K1 and by the activated coupling device A, and as a winding path gear with the shift element M being activated. Furthermore, a reverse gear R3 can be shifted by the first clutch K1 and by the activated coupling device A, and as a winding path gear with the shift element N being activated. In addition, it is apparent that a crawler gear C1 can be shifted by the first clutch K1 and by the activated coupling device G, and as a winding path gear with the shift element N being activated. Finally, an overdrive gear O1 can be shifted by the second clutch K2 and by the activated coupling device L, and as a winding path gear with the shift element M being activated. An overdrive gear O2 can be shifted by the second clutch K2 and by the activated coupling device L, and as a winding path gear with the shift element N being activated.

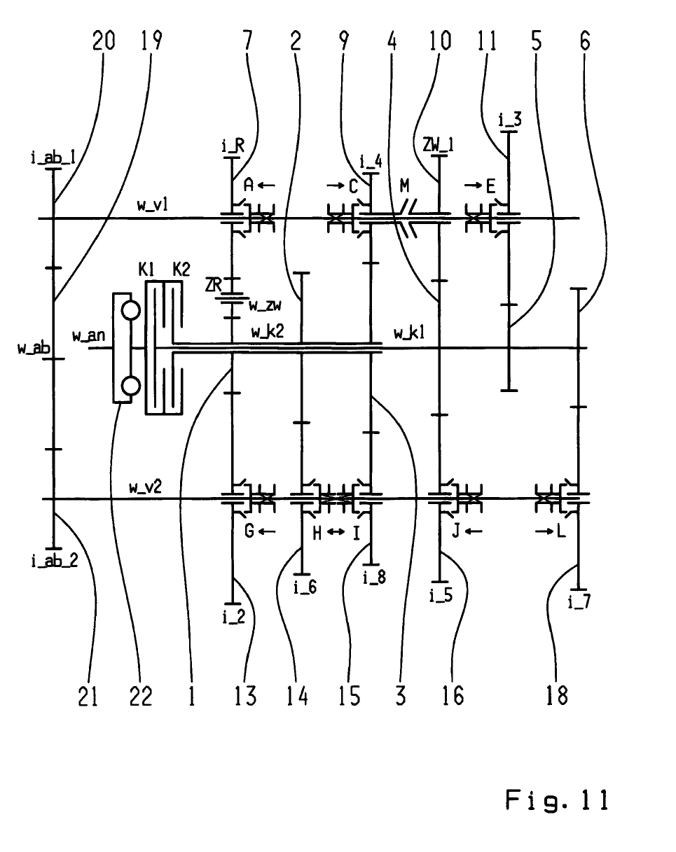

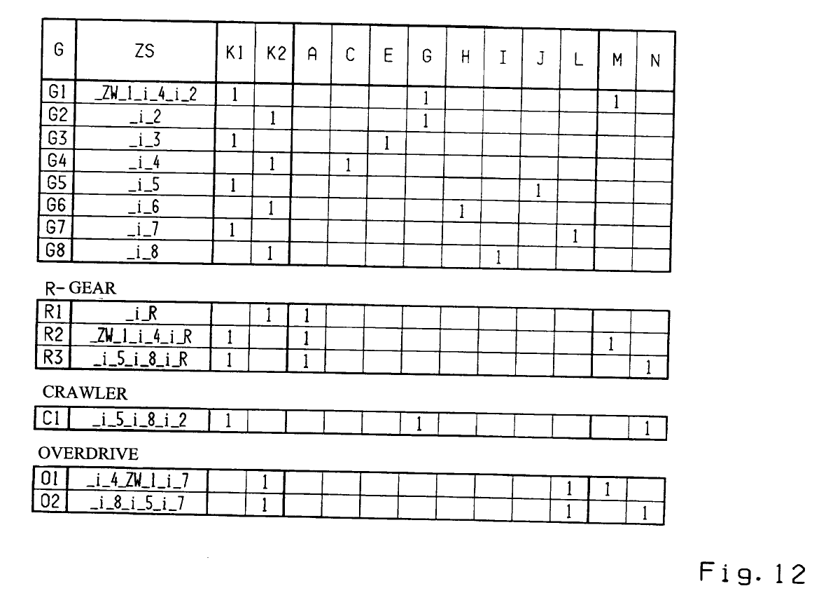

The table illustrated in FIG. 12 shows, by way of example, a shift pattern for the 6th variant embodiment of the eight-speed double clutch transmission according to FIG. 11.

From the shift pattern, it is apparent that the first forward gear G1 can be shifted by the first clutch K1 and by the activated coupling device G, and as a winding path gear with the shift element M being activated, the second forward gear G2 can be shifted by the second clutch K2 and by the activated coupling device G, the third forward gear G3 can be shifted by the first clutch K1 and by the activated coupling device E, the fourth forward gear G4 can be shifted by the second clutch K2 and by the activated coupling device C, the fifth forward gear G5 can be shifted by the first clutch K1 and by the activated coupling device J, the sixth forward gear G6 can be shifted by the second clutch K2 and by the activated coupling device H, the seventh forward gear G7 can be shifted by the first clutch K1 and by the activated coupling device L, and the eighth forward gear G8 can be shifted by the second clutch K2 and by the activated coupling device I. In this way, at least the first eight forward gears can be implemented as power shiftable (Isb.)

Furthermore, for example, a reverse gear R1 can be shifted by the second clutch K2 and by the activated coupling device A. A reverse gear R2 can be shifted by the first clutch K1 and by the activated coupling device A, and as a winding path gear with the shift element M being activated. Furthermore, a reverse gear R3 can be shifted by the first clutch K1 and by the activated coupling device A, and as a winding path gear with the shift element N being activated. In addition, it is apparent that a crawler gear C1 can be shifted by the first clutch K1 and by the activated coupling device G, and as a winding path gear with the shift element N being activated. Finally, an overdrive gear O1 can be shifted by the second clutch K2 and by the activated coupling device L, and as a winding path gear with the shift element M being activated. An overdrive gear O2 can be shifted by the second clutch K2 and by the activated coupling device L, and as a winding path gear with the shift element N being activated.

The table illustrated in FIG. 14 shows, by way of example, a shift pattern for the 7th variant embodiment of the eight-speed double clutch transmission according to FIG. 13.

From the shift pattern, it is apparent that the first forward gear G1 can be shifted by the first clutch K1 and by the activated coupling device G, and as a winding path gear with the shift element M being activated, the second forward gear G2 can be shifted by the second clutch K2 and by the activated coupling device G, the third forward gear G3 can be shifted by the first clutch K1 and by the activated coupling device F, the fourth forward gear G4 can be shifted by the second clutch K2 and by the activated coupling device H, the fifth forward gear G5 can be shifted by the first clutch K1 and by the activated coupling device K, the sixth forward gear G6 can be shifted by the second clutch K2 and by the activated coupling device I, the seventh forward gear G7 can be shifted by the first clutch K1 and by the activated coupling device E, and the eighth forward gear G8 can be shifted by the second clutch K2 and by the activated coupling device C. In this way, at least the first eight forward gears can be implemented as power shiftable (Isb.)

Furthermore, for example, a reverse gear R1 can be shifted by the first clutch K1 and by the activated coupling device J. A reverse gear R2 can be shifted by the second clutch K2 and by the activated coupling device J, and as a winding path gear with the shift element M being activated. Furthermore, a reverse gear R3 can be shifted by the first clutch K1 and by the activated coupling device G, and as a winding path gear with the shift element N being activated. A reverse gear R4 can be shifted by the first clutch K1 and by the activated coupling device H, and as a winding path gear with the shift element N being activated. A reverse gear R5 can be shifted by the first clutch K1 and by the activated coupling device I, and as a winding path gear with the shift element N being activated. Advantageously, the reverse gear R5 can be implemented as power shiftable, in particular relative to the first forward gear G1.

The table illustrated in FIG. 16 shows, by way of example, a shift pattern for the 8th variant embodiment of the eight-speed double clutch transmission according to FIG. 15.

From the shift pattern, it is apparent that the first forward gear G1 can be shifted by the first clutch K1 and by the activated coupling device F, the second forward gear G2 can be shifted by the second clutch K2 and by the activated coupling device C, the third forward gear G3 can be shifted by the first clutch K1 and by the activated coupling device J, the fourth forward gear G4 can be shifted by the second clutch K2 and by the activated coupling device A, the fifth forward gear G5 can be shifted by the first clutch K1 and by the activated coupling device E, the sixth forward gear G6 can be shifted by the second clutch K2 and by the activated coupling device H, the seventh forward gear G7 can be shifted by the first clutch K1 and by the activated coupling device K, and the eighth forward gear G8 can be shifted by the second clutch K2 and by the activated coupling device K, and as the winding path gear with the shift element M being activated. In this way, at least the first eight forward gears can be implemented as power shiftable (Isb.)

Furthermore, for example, a reverse gear R1 can be shifted by the second clutch K2 and by the activated coupling device I. A reverse gear R2 can be shifted by the first clutch K1 and by the activated coupling device I, and as a winding path gear with the shift element M being activated. Furthermore, a reverse gear R3 can be shifted by the second clutch K2 and by the activated coupling device D, and as a winding path gear with the shift element N being activated. A reverse gear R4 can be shifted by the second clutch K2 and by the activated coupling device F, and as a winding path gear with the shift element N being activated. Advantageously, the reverse gear R4 can be implemented as power shiftable, in particular relative to the first forward gear G1.

The table illustrated in FIG. 18 shows, by way of example, a shift pattern for the 9th variant embodiment of the eight-speed double clutch transmission according to FIG. 17.

From the shift pattern, it is apparent that the first forward gear G1 can be shifted by the first clutch K1 and by the activated coupling device J, the second forward gear G2 can be shifted by the second clutch K2 and by the activated coupling device C, the third forward gear G3 can be shifted by the first clutch K1 and by the activated coupling device L, the fourth forward gear G4 can be shifted by the second clutch K2 and by the activated coupling device A, the fifth forward gear G5 can be shifted by the first clutch K1 and by the activated coupling device K, the sixth forward gear G6 can be shifted by the second clutch K2 and by the activated coupling device H, the seventh forward gear G7 can be shifted by the first clutch K1 and by the activated coupling device E, and the eighth forward gear G8 can be shifted by the second clutch K2 and by the activated coupling device E, and as the winding path gear with the shift element M being activated. In this way, at least the first eight forward gears can be implemented as power shiftable (Isb.)

Furthermore, for example, a reverse gear R1 can be shifted by the second clutch K2 and by the activated coupling device I. A reverse gear R2 can be shifted by the first clutch K1 and by the activated coupling device I, and as a winding path gear with the shift element M being activated. Furthermore, a reverse gear R3 can be shifted by the first clutch K1 and by the activated coupling device C, and as a winding path gear with the shift element N being activated.

The table illustrated in FIG. 20 shows, by way of example, a shift pattern for the 10th variant embodiment of the eight-speed double clutch transmission according to FIG. 19.

From the shift pattern, it is apparent that the first forward gear G1 can be shifted by the first clutch K1 and by the activated coupling device J, the second forward gear G2 can be shifted by the second clutch K2 and by the activated coupling device C, the third forward gear G3 can be shifted by the first clutch K1 and by the activated coupling device L, the fourth forward gear G4 can be shifted by the second clutch K2 and by the activated coupling device G, the fifth forward gear G5 can be shifted by the first clutch K1 and by the activated coupling device K, the sixth forward gear G6 can be shifted by the second clutch K2 and by the activated coupling device H, the seventh forward gear G7 can be shifted by the first clutch K1 and by the activated coupling device E, and the eighth forward gear G8 can be shifted by the second clutch K2 and by the activated coupling device E, and as the winding path gear with the shift element M being activated. In this way, at least the first eight forward gears can be implemented as power shiftable (Isb.)

Furthermore, for example, a reverse gear R1 can be shifted by the second clutch K2 and by the activated coupling device I. A reverse gear R2 can be shifted by the first clutch K1 and by the activated coupling device I, and as a winding path gear with the shift element M being activated. Furthermore, a reverse gear R3 can be shifted by the second clutch K2 and by the activated coupling device D, and as a winding path gear with the shift element N being activated. A reverse gear R4 can be shifted by the first clutch K1 and by the activated coupling device C, and as a winding path gear with the shift element N being activated.

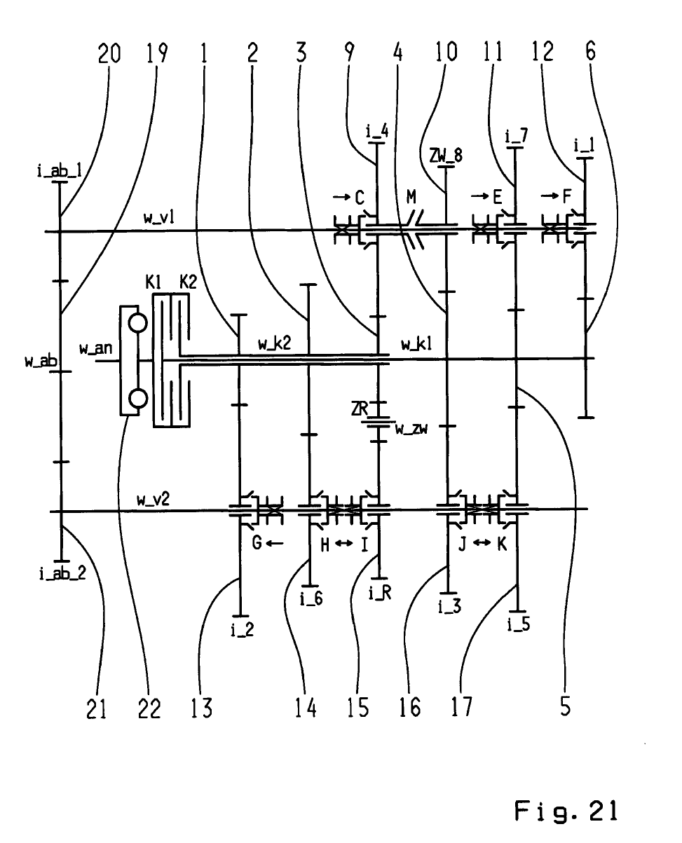

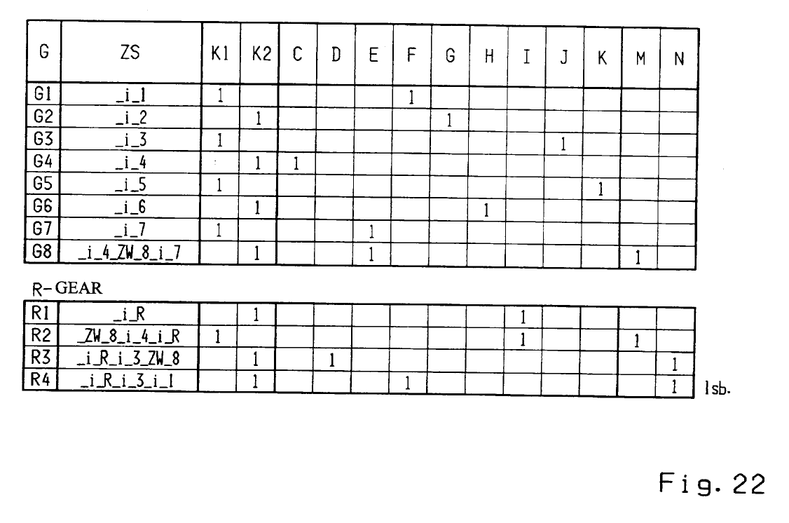

The table illustrated in FIG. 22 shows, by way of example, a shift pattern for the 11th variant embodiment of the eight-speed double clutch transmission according to FIG. 21.

From the shift pattern, it is apparent that the first forward gear G1 can be shifted by the first clutch K1 and by the activated coupling device F, the second forward gear G2 can be shifted by the second clutch K2 and by the activated coupling device G, the third forward gear G3 can be shifted by the first clutch K1 and by the activated coupling device J, the fourth forward gear G4 can be shifted by the second clutch K2 and by the activated coupling device C, the fifth forward gear G5 can be shifted by the first clutch K1 and by the activated coupling device K, the sixth forward gear G6 can be shifted by the second clutch K2 and by the activated coupling device H, the seventh forward gear G7 can be shifted by the first clutch K1 and by the activated coupling device E, and the eighth forward gear G8 can be shifted by the second clutch K2 and by the activated coupling device E, and as the winding path gear by the activated shift element M. In this way, at least the first eight forward gears can be implemented as power shiftable (Isb.)

Furthermore, for example, a reverse gear R1 can be shifted by the second clutch K2 and by the activated coupling device I. A reverse gear R2 can be shifted by the first clutch K1 and by the activated coupling device I, and as a winding path gear with the shift element M being activated. Furthermore, a reverse gear R3 can be shifted by the second clutch K2 and by the activated coupling device D, and as a winding path gear with the shift element N being activated. A reverse gear R4 can be shifted by the second clutch K2 and by the activated coupling device F, and as a winding path gear with the shift element N being activated. Advantageously, the reverse gear R4 can be implemented as power shiftable, in particular relative to the first forward gear G1. The coupling device D, which is not shown in detail, is used to rigidly connect the idler gear 10 to the first countershaft w_v1 in the activated state.

From the shift patterns of the first, second, and sixth variant embodiments according to FIGS. 2, 4, and 12, it is apparent in detail that, starting from the first clutch K1, in the first forward gear G1 the gear stages ZW_1, i_4, and i_2 are used, wherein the two subtransmissions are coupled to one another by the activated shift element M. In the second forward gear G2 the gear stage i_2, in the third forward gear G3 the gear stage i_3, in the fourth forward gear G4 the gear stage i_4, in the fifth forward gear G5 the gear stage i_5, in the sixth forward gear G6 the gear stage i_6, in the seventh forward gear G7 the gear stage i_7, and in the eighth forward gear G8 the gear stage i_8 are used.

In addition, starting from the second clutch K2, in the reverse gear R1 the gear stage i_R is used. Furthermore, starting from the first clutch K1, in a further reverse gear R2 the gear stages ZW_1, i_4, and i_R are used, wherein the shift element M is activated in order to couple the two subtransmissions. Starting from the first clutch K1, in the reverse gear R3 the gear stages i_5, i_8, and i_R are used, wherein the shift element N is activated in order to couple the two subtransmissions.

Starting from the first clutch K1, in the crawler gear C1 the gear stages i_5, i_8, and i_2 are used, wherein the two subtransmissions are coupled with the shift element N being activated.

Starting from the second clutch K2, in the overdrive gear O1 the gear stages i_4, ZW_1, and i_7 are used, wherein the two subtransmissions are coupled with the shift element M being activated.

Starting from the second clutch K2, in the overdrive gear O2 the gear stages i_8, i_5, and i_7 are used, wherein the two subtransmissions are coupled with the shift element N being activated.

From the shift patterns of the third, fourth, and fifth variant embodiments according to FIGS. 5 to 10, it is apparent in detail that, starting from the first clutch K1, in the first forward gear G1 the gear stages ZW_1, i_6, and i_2 are used, wherein the two subtransmissions are coupled to one another by the activated shift element M. In the second forward gear G2 the gear stage i_2, in the third forward gear G3 the gear stage i_3, in the fourth forward gear G4 the gear stage i_4, in the fifth forward gear G5 the gear stage i_5, in the sixth forward gear G6 the gear stage i_6, in the seventh forward gear G7 the gear stage i_7, and in the eighth forward gear G8 the gear stage i_8 are used.

From the shift pattern according to FIG. 6, it is apparent that, starting from the first clutch K1, in the reverse gear R1 the gear stages ZW_1, i_6, and i_R are used, wherein the shift element M is activated in order to couple the two subtransmissions. Starting from the first clutch K1, in the reverse gear R2 the gear stages i_5, i_8, and i_R are used, wherein the shift element N is activated in order to couple the two subtransmissions. Starting from the first clutch K1, in the crawler gear C1 the gear stages i_5, i_8, and i_2 are used, wherein the two subtransmissions are coupled with the shift element N being activated. Starting from the second clutch K2, in the overdrive gear O1 the gear stages i_6, ZW_1, and i_7 are used, wherein the two subtransmissions are coupled with the shift element M being activated. Starting from the second clutch K2, in the overdrive gear O2 the gear stages i_8, i_5, and i_7 are used, wherein the two subtransmissions are coupled with the shift element N being activated.

It is also apparent from the shift pattern according to FIG. 8 that, starting from the first clutch K1, in the reverse gear R1 the gear stage i_R is used. Furthermore, starting from the second clutch K2, in the further reverse gear R2 the gear stages i_6, ZW_1, and i_R are used, wherein the shift element M is activated in order to couple the two subtransmissions. Starting from the first clutch K1, in the crawler gear C1 the gear stages i_5, i_8, and i_2 are used, wherein the two subtransmissions are coupled by the activated shift element N. Starting from the second clutch K2, in the overdrive gear O1 the gear stages i_6, ZW_1, and i_7 are used, wherein the two subtransmissions are coupled with the shift element M being activated. Starting from the second clutch K2, in the overdrive gear O2 the gear stages i_8, i_5, and i_7 are used, wherein the two subtransmissions are coupled with the shift element N being activated.

It is also apparent from the shift pattern according to FIG. 10 that, starting from the second clutch K2, in the reverse gear R1 the gear stage i_R is used. Furthermore, starting from the first clutch K1, in the further reverse gear R2 the gear stages ZW_1, i_6, and i_R are used, wherein the shift element M is activated in order to couple the two subtransmissions. Starting from the first clutch K1, in the reverse gear R3 the gear stages i_5, i_8, and i_R are used, wherein the shift element N is activated in order to couple the two subtransmissions. Starting from the first clutch K1, in the crawler gear C1 the gear stages i_5, i_8, and i_2 are used, wherein the two subtransmissions are coupled by the activated shift element N. Starting from the second clutch K2, in the overdrive gear O1 the gear stages i_6, ZW_1, and i_7 are used, wherein the two subtransmissions are coupled with the shift element M being activated. Starting from the second clutch K2, in the overdrive gear O2 the gear stages i_8, i_5, and i_7 are used, wherein the two subtransmissions are coupled with the shift element N being activated.

From the shift pattern of the seventh variant embodiment according to FIGS. 13 and 14, it is apparent in detail that, starting from the first clutch K1, in the first forward gear G1 the gear stages ZW_1, i_8, and i_2 are used, wherein the two subtransmissions are coupled to one another by the activated shift element M. In the second forward gear G2 the gear stage i_2, in the third forward gear G3 the gear stage i_3, in the fourth forward gear G4 the gear stage i_4, in the fifth forward gear G5 the gear stage i_5, in the sixth forward gear G6 the gear stage i_6, in the seventh forward gear G7 the gear stage i_7, and in the eighth forward gear G8 the gear stage i_8 are used.

It is also apparent from the shift pattern according to FIG. 14 that, starting from the first clutch K1, in the reverse gear R1 the gear stage i_R is used. Furthermore, starting from the second clutch K2, in the further reverse gear R2 the gear stages i_8, ZW_1, and i_R are used, wherein the shift element M is activated in order to couple the two subtransmissions. Starting from the first clutch K1, in the reverse gear R3 the gear stages i_R, i_6, and i_2 are used, wherein the shift element N is activated in order to couple the two subtransmissions. Starting from the first clutch K1, in the reverse gear R4 the gear stages i_R, i_6, and i_4 are used, wherein the shift element N is activated in order to couple the two subtransmissions. Starting from the first clutch K1, in the reverse gear R5 the gear stages i_R, i_6, and i_8 are used, wherein the shift element N is activated in order to couple the two subtransmissions.

From the shift patterns of the eighth, ninth, and tenth variant embodiments according to FIGS. 15-20, it is apparent in detail that, starting from the first clutch K1, in the first forward gear G1 the gear stage i_1, in the second forward gear G2 the gear stage i_2, in the third forward gear G3 the gear stage i_3, in the fourth forward gear G4 the gear stage i_4, in the fifth forward gear G5 the gear stage i_5, in the sixth forward gear G6 the gear stage i_6, in the seventh forward gear G7 the gear stage i_7, and, starting from the second clutch K2, in the eighth forward gear G8 the gear stages i_2, ZW_8, and i_7 are used, wherein the two subtransmissions are coupled to one another by the activated shift element M.

It is also apparent from the shift pattern according to FIG. 16 that, starting from the second clutch K2, in the reverse gear R1 the gear stage i_R is used. Furthermore, starting from the first clutch K1, in the further reverse gear R2 the gear stages ZW_8, i_2, and i_R are used, wherein the shift element M is activated in order to couple the two subtransmissions. Starting from the second clutch K2, in the reverse gear R3 the gear stages i_R, i_3, and ZW_8 are used, wherein the shift element N is activated in order to couple the two subtransmissions. Starting from the second clutch K2, in the reverse gear R4 the gear stages i_R, i_3, and i_1 are used, wherein the shift element N is activated in order to couple the two subtransmissions.

It is also apparent from the shift pattern according to FIG. 18 that, starting from the second clutch K2, in the reverse gear R1 the gear stage i_R is used. Furthermore, starting from the first clutch K1, in the further reverse gear R2 the gear stages ZW_8, i_2, and i_R are used, wherein the shift element M is activated in order to couple the two subtransmissions. Starting from the first clutch K1, in the reverse gear R3 the gear stages i_1, i_R, and i_2 are used, wherein the shift element N is activated in order to couple the two subtransmissions.

It is also apparent from the shift pattern according to FIG. 20 that, starting from the second clutch K2, in the reverse gear R1 the gear stage i_R is used. Furthermore, starting from the first clutch K1, in the further reverse gear R2 the gear stages ZW_8, i_2, and i_R are used, wherein the shift element M is activated in order to couple the two subtransmissions. Starting from the second clutch K2, in the reverse gear R3 the gear stages i_R, i_1, and ZW_8 are used, wherein the shift element N is activated in order to couple the two subtransmissions. Starting from the first clutch K1, in the reverse gear R4 the gear stages i_1, i_R, and i_2 are used, wherein the shift element N is activated in order to couple the two subtransmissions.

From the shift pattern of the 11th variant embodiment according to FIGS. 21 and 22, it is apparent in detail that, starting from the first clutch K1, in the first forward gear G1 the gear stage i_1, in the second forward gear G2 the gear stage i_2, in the third forward gear G3 the gear stage i_3, in the fourth forward gear G4 the gear stage i_4, in the fifth forward gear G5 the gear stage i_5, in the sixth forward gear G6 the gear stage i_6, in the seventh forward gear G7 the gear stage i_7, and, starting from the second clutch K2, in the eighth forward gear G8 the gear stages i_4, ZW_8, and i_7 are used, wherein the two subtransmissions are coupled to one another by the activated shift element M.

It is also apparent from the shift pattern according to FIG. 22 that, starting from the second clutch K2, in the reverse gear R1 the gear stage i_R is used. Furthermore, starting from the first clutch K1, in the further reverse gear R2 the gear stages ZW_8, i_4, and i_R are used, wherein the shift element M is activated in order to couple the two subtransmissions. Starting from the second clutch K2, in the reverse gear R3 the gear stages i_R, i_3, and ZW_8 are used, wherein the shift element N is activated in order to couple the two subtransmissions. Starting from the second clutch K2, in the reverse gear R4 the gear stages i_R, i_3, and i_1 are used, wherein the shift element N is activated in order to couple the two subtransmissions.

In summary, it is apparent from the first and second variant embodiments according to FIGS. 1 to 4 that the first forward gear is implemented as a winding path gear by the additional gear stage ZW_1, which is not used in any other direct forward gear, by the gear stage of the fourth gear, and by the gear stage of the second gear. Furthermore, two reverse gears which are power shiftable relative to each other are provided. In addition, an overdrive gear, which is power shiftable relative to the seventh forward gear, is provided as an alternative eighth forward gear to achieve fuel savings.

In the first variant embodiment, good stepping adaptation is achieved, particularly in the higher gears, as a result of the arrangement of the gear stages of the sixth and seventh gears at single gear planes.

Specifically, for the first variant embodiment, with the first gear plane 7-1 designed as a single gear plane, the idler gear 7 is used for a forward gear G6. With the second gear plane 8-14 designed as a dual gear plane, the idler gear 8 is used for three reverse gears R1 to R3, and the idler gear 14 is used for three forward gears G1, G2, C1. With the third gear plane 9-15 designed as a dual gear plane, the idler gear 9 is used for three forward gears G1, G4, O1 and for one reverse gear R2, and the idler gear 15 is used for three forward gears G8, C1, O2 and for one reverse gear R3. With the third fourth plane 10-16 designed as a dual gear plane, the idler gear 10 is used for two forward gears G1, O1 and for one reverse gear R2, and the idler gear 16 is used for three forward gears G5, C1, O2 and for one reverse gear R3. With the fifth gear plane 11-5 designed as a single gear plane, the idler gear 11 is used for one forward gear G3. Finally, with the sixth gear plane 6-18 designed as a single gear plane, the idler gear 18 is used for three forward gears G7, O1, O2.

Because of the fact that in the second variant embodiment the gear stages of the second, third, and fourth gears and of the reverse gear and also the additional gear stage ZW_1 are disposed on the first countershaft, the loads applied to the second countershaft are lower, resulting in advantages with respect to the shaft and bearing configuration.

Specifically, for the second variant embodiment, with the first gear plane 7-1 designed as a single gear plane, the idler gear 7 is used for three forward gears G1, G2, C1. With the second gear plane 8-14 designed as a dual gear plane, the idler gear 8 is used for three reverse gears R1 to R3, and the idler gear 14 is used for one forward gear G6. With the third gear plane 9-15 designed as a dual gear plane, the idler gear 9 is used for three forward gears G1, G4, O1 and for one reverse gear R2, and the idler gear 15 is used for three forward gears G8, C1, O2 and for one reverse gear R3. With the third fourth plane 10-16 designed as a dual gear plane, the idler gear 10 is used for two forward gears G1, O1 and for one reverse gear R2, and the idler gear 16 is used for three forward gears G5, C1, O2 and for one reverse gear R3. With the fifth gear plane 11-5 designed as a single gear plane, the idler gear 11 is used for one forward gear G3. Finally, in the sixth gear plane 6-18 designed as a single gear plane, the idler gear 18 is used for three forward gears G7, O1, O2.

In the third and fourth variant embodiments according to FIGS. 5 to 8, the first forward gear can be implemented as a winding path gear by the additional gear stage ZW_1 and by the gear stages of the sixth and second gears. Furthermore, an overdrive gear, which is power shiftable relative to the seventh forward gear, can be implemented as an alternative eighth forward gear to achieve fuel savings.

In the third variant embodiment, better stepping adaptation is achieved as a result of the arrangement of the gear stages of the third, fourth, and seventh gears on single gear planes.

Specifically, for the third variant embodiment, with the first gear plane 7-13 designed as a dual gear plane, the idler gear 7 is used for three forward gears G1, G2, C1, and the idler gear 13 is used for two reverse gears R1, R2. In the second gear plane 8-2 designed as a single gear plane, the idler gear 8 is used for one forward gear G4. With the third gear plane 9-15 designed as a dual gear plane, the idler gear 9 is used for three forward gears G1, G6, O1 and for one reverse gear R1, and the idler gear 15 is used for three forward gears G8, C1, O2 and for one reverse gear R2. In the third fourth plane 10-16 designed as a dual gear plane, the idler gear 10 is used for two forward gears G1, O1 and for one reverse gear R1, and the idler gear 16 is used for three forward gears G5, C1, O2 and for one reverse gear R2. With the fifth gear plane 11-5 designed as a single gear plane, the idler gear 11 is used for one forward gear G3. Finally, in the sixth gear plane 6-18 designed as a single gear plane, the idler gear 18 is used for three forward gears G7, O1, O2.

Because in the fourth variant embodiment the gear stages of the first and third gears and of the reverse gear are shifted by the first clutch, the load on the second clutch is lower. As a result, the second clutch can be dimensioned smaller. Furthermore, two reverse gears which are power shiftable relative to each other are attained.

Specifically, for the fourth variant embodiment, with the first gear plane 7-1 designed as a single gear plane, the idler gear 7 is used for three forward gears G1, G2, C1. With the second gear plane 2-14 designed as a single gear plane, the idler gear 14 is used for one forward gear G4. With the third gear plane 9-15 designed as a dual gear plane, the idler gear 9 is used for three forward gears G1, G6, O1 and for one reverse gear R2, and the idler gear 15 is used for three forward gears G8, C1, O2. With the third fourth plane 10-16 designed as a dual gear plane, the idler gear 10 is used for two forward gears G1, O1 and for one reverse gear R2, and the idler gear 16 is used for three forward gears G5, C1, O2. In the fifth gear plane 11-17 designed as a dual gear plane, the idler gear 11 is used for one forward gear G3, and the idler gear 17 is used for two reverse gears R1, R2. In the sixth gear plane 6-18 designed as a single gear plane, the idler gear 18 is used for three forward gears G7, O1, O2.

In the fifth variant embodiment according to FIGS. 9 to 10, the first forward gear can be implemented as a winding path gear by the additional gear stage ZW_1 and by the gear stages of the sixth and second gears. Furthermore, two reverse gears which are power shiftable relative to each other are provided. Furthermore, an overdrive gear, which is power shiftable relative to the seventh forward gear, can be implemented as an alternative eighth forward gear to achieve fuel savings.

Specifically, for the fifth variant embodiment, with the first gear plane 7-13 designed as a dual gear plane, the idler gear 7 is used for three reverse gears R1 to R3, and the idler gear 13 is used for three forward gears G1, G2, C1. In the second gear plane 2-14 designed as a single gear plane, the idler gear 14 is used for one forward gear G4. With the third gear plane 9-15 designed as a dual gear plane, the idler gear 9 is used for three forward gears G1, G6, O1 and for one reverse gear R2, and the idler gear 15 is used for three forward gears G8, C1, O2 and for one reverse gear R3. In the third fourth plane 10-16 designed as a dual gear plane, the idler gear 10 is used for two forward gears G1, O1 and for one reverse gear R2, and the idler gear 16 is used for three forward gears G5, C1, O2 and for one reverse gear R3. With the fifth gear plane 11-5 designed as a single gear plane, the idler gear 11 is used for one forward gear G3. In the sixth gear plane 6-18, the idler gear 18 is used for three forward gears G7, O1, O2.

In the sixth variant embodiment according to FIGS. 11 and 12, the first forward gear can be implemented as a winding path gear by the additional gear stage and by the gear stages of the fourth and second gears. Furthermore, two reverse gears that are power shiftable relative to the first reverse gear R1 are attained (R2, R3). In addition, two overdrive gears, which are power shiftable relative to the seventh forward gear, can be implemented as alternative eighth forward gears to achieve fuel savings. Good stepping adaptation is achieved, particularly in the higher gears, as a result of the arrangement of the gear stages of the sixth and seventh gears at single gear planes.

Specifically, it is apparent from the shift pattern according to FIG. 12, with the first gear plane 7-13 designed as a dual gear plane, that the idler gear 7 is used for three reverse gears R1, R2, R3, and the idler gear 13 is used for three forward gears G1, G2, C1. In the second gear plane 2-14 designed as a single gear plane, the idler gear 14 is used for one forward gear G6. With the third gear plane 9-15 designed as a dual gear plane, the idler gear 9 is used for three forward gears G1, G4, O1 and for one reverse gear R2, and the idler gear 15 is used for three forward gears G8, C1, O2 and for one reverse gear R3. In the third fourth plane 10-16 designed as a dual gear plane, the idler gear 10 is used for two forward gears G1, O1 and for one reverse gear R2, and the idler gear 16 is used for three forward gears G5, C1, O2 and for one reverse gear R3. With the fifth gear plane 11-5 designed as a single gear plane, the idler gear 11 is used for one forward gear G3. With the sixth gear plane 6-18 designed as a single gear plane, the idler gear 18 is used for three forward gears G7, O1, O2.

In the seventh variant embodiment according to FIGS. 13 and 14, the first forward gear can be implemented as a winding path gear by the additional gear stage and by the gear stages of the eighth and second gears. Furthermore, two reverse gears which are power shiftable relative to each other are attained. Good stepping adaptation is achieved, particularly in the lower gears, as a result of the arrangement of the gear stages of the second, third, and fourth gears at single gear planes.

Specifically, it is apparent from the shift pattern of the seventh variant embodiment, that, in the first gear plane 1-13 designed as a single gear plane, the idler gear 13 is used for two forward gears G1, G2 and for one reverse gear R3. In the second gear plane 2-14 designed as a single gear plane, the idler gear 14 is used for one forward gear G4 and for one reverse gear R4. With the third gear plane 9-15 designed as a dual gear plane, the idler gear 9 is used for two forward gears G1, G8 and for two reverse gears R2, R5, and the idler gear 15 is used for one forward gear G6 and for three reverse gears R3, R4, R5. In the fourth gear plane 10-16 designed as a dual gear plane, the idler gear 10 is used for one forward gear G1 and for one reverse gear R2, and the idler gear 16 is used for five reverse gears R1 to R5. With the fifth gear plane 11-17 designed as a dual gear plane, the idler gear 11 is used for one forward gear G7, and the idler gear 17 is used for one forward gear G5. In the sixth gear plane 12-6 designed as a single gear plane, the idler gear 12 is used for one forward gear G3.

In summary, in the eighth, ninth, and tenth variant embodiments according to FIGS. 15-20, an eighth forward gear is obtained as a winding path gear by the gear stage of the second gear, the additional gear stage ZW_8, and the gear stage of the seventh gear. Furthermore, two reverse gears which are power shiftable relative to each other are attained.

In the eighth variant embodiment, the use of four dual acting synchronizers or coupling devices enables lower construction costs and a smaller construction space requirement. For this purpose, for example, the single acting coupling devices illustrated in FIG. 15 can be combined into dual acting coupling devices on the first countershaft. In principle, this is also possible in other variant embodiments when the single acting coupling devices are disposed accordingly next to one another.

Specifically, for the eighth variant embodiment, in the first gear plane 7-1 designed as a single gear plane, the idler gear 7 is used for one forward gear G4. In the second gear plane 2-14 designed as a single gear plane, the idler gear 14 is used for one forward gear G6. In the third gear plane 9-15 designed as a dual gear plane, the idler gear 9 is used for two forward gears G2, G8 and for one reverse gear R2, and the idler gear 15 is used for four reverse gears R1 to R4. With the fourth gear plane 10-16 designed as a dual gear plane, the idler gear 10 is used for one forward gear G8 and for two reverse gears R2, R3, and the idler gear 16 is used for one forward gear G3 and for two reverse gears R3, R4. In the fifth gear plane 11-17 designed as a dual gear plane, the idler gear 11 is used for one forward gear G5, and the idler gear 17 is used for two forward gears G7, G8. Finally, in the sixth gear plane 12-6 designed as a single gear plane, the idler gear 12 is used for one forward gear G1 and for one reverse gear R4.

In the ninth variant embodiment, the load is evenly distributed among the two countershafts, thereby achieving advantages with respect to the shaft and bearing dimensions.

Specifically, for the ninth variant embodiment, in the first gear plane 7-1 designed as a single gear plane, the idler gear 7 is used for one forward gear G4. With the second gear plane 2-14 designed as a single gear plane, the idler gear 14 is used for one forward gear G6. In the third gear plane 9-15 designed as a dual gear plane, the idler gear 9 is used for two forward gears G2, G8 and for two reverse gears R2, R3, and the idler gear 15 is used for three reverse gears R1 to R3. In the fourth gear plane 10-16 designed as a dual gear plane, the idler gear 10 is used for one forward gear G8 and for one reverse gear R2, and the idler gear 16 is used for one forward gear G1 and for one reverse gear R3. With the fifth gear plane 11-17 designed as a dual gear plane, the idler gear 11 is used for two forward gears G7, G8, and the idler gear 17 is used for one forward gear G5. Finally, in the sixth gear plane 6-18 designed as a single gear plane, the idler gear 18 is used for one forward gear G3.

In the 10th variant embodiment, the eighth forward gear is implemented as a winding path gear by the gear stage of the second gear, the additional gear stage ZW_8, and the gear stage of the seventh gear. Furthermore, two reverse gears which are power shiftable relative to each other are attained. Because of the fact that only the gear stages of the second and the seventh gears and the additional gear stage ZW_8 are disposed on the first countershaft, advantages are attained with respect to the shaft load for the first countershaft, and advantages are also achieved with respect to the shaft and bearing dimensions.

Specifically, for the 10th variant embodiment, in the first gear plane 1-13 designed as a single gear plane, the idler gear 13 is used for one forward gear G4. In the second gear plane 2-14 designed as a single gear plane, the idler gear 14 is used for one forward gear G6. In the third gear plane 9-15 designed as a dual gear plane, the idler gear 9 is used for two forward gears G2, G8 and for two reverse gears R2, R4, and the idler gear 15 is used for four reverse gears R1 to R4. In the fourth gear plane 10-16 designed as a dual gear plane, the idler gear 10 is used for one forward gear G8 and for two reverse gears R2, R3, and the idler gear 16 is used for one forward gear G1 and for two reverse gears R3, R4. In the fifth gear plane 11-17 designed as a dual gear plane, the idler gear 11 is used for two forward gears G7, G8, and the idler gear 17 is used for one forward gear G5. Finally, in the sixth gear plane 6-18 designed as a single gear plane, the idler gear 18 is used for one forward gear G3.

In the 11th variant embodiment according to FIGS. 21 and 22, the eighth forward gear can be implemented as a winding path gear by the gear stage of the fourth gear, by the additional gear stage ZW_8, and the gear stage of the seventh gear. Furthermore, two reverse gears which are power shiftable relative to each other are possible. Good stepping adaptation is achieved, particularly in the lower gears, as a result of the arrangement of the gear stages of the first and second gears at single gear planes.

Specifically, for the 11th variant embodiment, in the first gear plane 1-13 designed as a single gear plane, the idler gear 13 is used for one forward gear G2. In the second gear plane 2-14 designed as a single gear plane, the idler gear 14 is used for one forward gear G6. With the third gear plane 9-15 designed as a dual gear plane, the idler gear 9 is used for two forward gears G4, G8 and for one reverse gear R2, and the idler gear 15 is used for four reverse gears R1 to R4. With the fourth gear plane 10-16 designed as a dual gear plane, the idler gear 10 is used for one forward gear G8 and for two reverse gears R2, R3, and the idler gear 16 is used for one forward gear G3 and for two reverse gears R3, R4. With the fifth gear plane 11-17 designed as a dual gear plane, the idler gear 11 is used for two forward gears G7, G8, and the idler gear 17 is used for one forward gear G5. Finally, in the sixth gear plane 12-6 designed as a single gear plane, the idler gear 12 is used for one forward gear G1 and for one reverse gear R4.

It is possible to use at least one additional gear stage ZW_x, such as ZW_8 or ZW_1, which is not used in a direct forward gear, for winding path gears in one, or also in several of the variant embodiments. The use of an additional gear stage is apparent from the respective figures of the variant embodiments.

It is also possible to use gear wheels x1, x2, . . . , x7, x8 for additional winding path gears, which can be added to a single gear plane, whereby the sequential numbering of the gear wheels x1, x2, . . . , x7, x8 is performed as follows. The sequential numbering begins with the first gear wheel x1 of the first countershaft w_v1, starting from the associated output stage i_ab_1, continuously up to the fourth gear wheel x4, wherein the first gear wheel on the second countershaft w_v2, starting from the associated output stage i_ab_2, is labeled x5 and the remaining gear wheels are numbered continuously up to x8. If the additional gear wheel x1, x2, . . . x7, x8 is used within the scope of a reverse gear transmission ratio, a rotation reversal takes place, such as by the use of an intermediate gear ZR on an intermediate shaft w_zw or the like.

Due to these intended multiple uses of individual idler gears, in all variant embodiments of the double clutch transmission fewer gear planes and therefore fewer components are required, thereby bringing about advantageous construction space and cost savings.

Independent of the respective variant embodiment, the number “1” in a field of the respective table of the shift patterns according to FIGS. 2, 4, 6, 8, 10, 12, 14, 16, 18, 20 and 22 means that the associated clutch K1, K2, or the associated coupling device A, B, C, D, E, F, G, H, I, J, K, L or the associated shift element M, N, are engaged or activated. In contrast, a free field in the respective table of the shift patterns according to FIGS. 2, 4, 6, 8, 10, 12, 14, 16, 18, 20 and 22 means that the associated clutch K1, K2, or the associated coupling device A, B, C, D, E, F, G, H, I, J, K, L, or the associated shift element M, N, are disengaged.

Furthermore, in many cases there is the possibility to engage additional coupling or shift elements, without influencing the flow of power. In this way, a gear preselection may be enabled.

### REFERENCE NUMERALS

1 Fixed gear of the second transmission input shaft
2 Fixed gear of the second transmission input shaft
3 Fixed gear of the second transmission input shaft
4 Fixed gear of the first transmission input shaft
5 Fixed gear of the first transmission input shaft
6 Fixed gear of the first transmission input shaft
7 Idler gear of the first countershaft
8 Idler gear of the first countershaft
9 Idler gear of the first countershaft
10 Idler gear of the first countershaft
11 Idler gear of the first countershaft
12 Idler gear of the first countershaft
13 Idler gear of the second countershaft
14 Idler gear of the second countershaft
15 Idler gear of the second countershaft
16 Idler gear of the second countershaft
17 Idler gear of the second countershaft
18 Idler gear of the second countershaft
19 Fixed gear of the output shaft
20 Output gear of the first countershaft
21 Output gear of the second countershaft
22 Torsion vibration damper
K1 First clutch
K2 Second clutch
w_an Drive shaft
w_ab Output shaft
w_v1 First countershaft
w_v2 Second countershaft
w_k1 First transmission input shaft
w_k2 Second transmission input shaft
A Coupling device
B Coupling device
C Coupling device
D Coupling device
E Coupling device
F Coupling device
G Coupling device
H Coupling device
I Coupling device
J Coupling device
K Coupling device
L Coupling device
i_1 Gear stage first forward gear
i_2 Gear stage second forward gear
i_3 Gear stage third forward gear
i_4 Gear stage fourth forward gear
i_5 Gear stage fifth forward gear
i_6 Gear stage sixth forward gear
i_7 Gear stage seventh forward gear
i_8 Gear stage eighth forward gear
i_R Gear stage reverse gear
ZW_1 Additional gear stage for winding path gears
ZW_8 Additional gear stage for winding path gears
i_ab_1 Output stage on the first countershaft
i_ab_2 Output stage on the second countershaft
G1 First forward gear
G2 Second forward gear
G3 Third forward gear
G4 Fourth forward gear
G5 Fifth forward gear
G6 Sixth forward gear
G7 Seventh forward gear
G8 Eighth forward gear
C1 Crawler gear
O1 Overdrive gear
O2 Overdrive gear
R1 Reverse gear
R2 Reverse gear
R3 Reverse gear
R4 Reverse gear
R5 Reverse gear
w_zw Intermediate shaft
ZR Intermediate gear for rotation reversal
ZS Gear stage used
M Shift element
N Shift element, optional
S_ab1 Coupling device on the output stage, optional
S_ab2 Coupling device on the output stage, optional
psh. power shiftable

1-6. (canceled)

7. A double clutch transmission comprising:
first and second clutches (K1, K2), each comprising an input side connected to a drive shaft (w_an) and an output side connected to one of first and second transmission input shafts (w_K1, w_K2) arranged coaxially with each other;
at least first and second countershafts (w_v1, w_v2) on which toothed idler gearwheels (7, 8, 9, 10, 11, 12, 13, 14, 15, 16, 17, 18) are situated;
toothed fixed gearwheels (1, 2, 3, 4, 5, 6) being disposed on the first and the second transmission input shafts (w_k1, w_k2) in a rotationally fixed manner and each of the fixed gearwheels (1, 2, 3, 4, 5, 6) meshing with at least one of the idler gearwheels (7, 8, 9, 10, 11, 12, 13, 14, 15, 16, 17),
a plurality of coupling devices (A, B, C, E, F, G, H, I, K, L) for connecting one of the idler gearwheels (7, 8, 9, 10, 11, 12, 13, 14, 15, 16, 17, 18) to one of the first and the second countershafts (w_v1, w_v2) in a rotationally fixed manner,
each on the first and the second countershafts (w_v1, w_v2) having an output gear (20, 21) which is coupled to a gearing of an output shaft (w_ab),
at least one shift element (M) for connecting two toothed gearwheels in a rotationally fixed manner whereby at least several power shiftable forward gears (1, 2, 3, 4, 5, 6, 7, 8) and at least one reverse gear (R1, R2, R3, R4, R5) being shiftable,
wherein a maximum of six gear planes (7-1, 1-13, 7-13, 8-2, 2-14, 8-14, 9-15, 10-16, 11-5, 11-17, 12-6, 6-18) are provided, three of the six gear planes are dual gear planes (7-13, 8-14, 9-15, 10-16, 11-17) and for every dual gear plane (7-13, 8-14, 9-15, 10-16, 11-17) an idler gearwheel (7, 8, 9, 10, 11, 12, 13, 14, 15, 16, 17, 18) of the first and the second countershafts (w_v1, w_v2) being associated with a fixed gearwheel (1, 2, 3, 4, 5, 6) of one of the first and the second transmission input shafts (w_k1, w_k2), and for at least one of the double gear planes (7-13, 8-14, 9-15, 10-16, 11-17) at least one idler gearwheel (7, 8, 9, 10, 11, 12, 13, 14, 15, 16, 17, 18) can be utilized for at least two gears, and three of the six gear planes are single gear planes (1-13, 7-1, 8-2, 2-14, 11-5, 6-18, 12-6) in which an idler gearwheel (7, 8, 11, 12, 13, 14, 18) of one of the first and the second countershafts (w_v1, w_v2) is associated with a fixed gearwheel (1, 2, 5, 6) of one of the first and the second transmission input shafts (w_K1, w_K2) so that at least one power shiftable winding path gear can be shifted by the at least one shift element (M).

8. The double clutch transmission according to claim 7, wherein the idler gearwheel (9) of a second subtransmission is connected with the idler gearwheel (10) of a first subtransmission by the activated the at least one shift element (M) on the first countershaft (w_v1) so that at least one of a first forward gear (G1) and an eighth forward gear (G8) and at least one reverse gear (R1, R2) are shiftable as winding path gears by engagement of the at least one shift element (M).

9. The double clutch transmission according to claim 7, wherein an idler gearwheel (15) of a second subtransmission is connectable to an idler gear (16) of a first subtransmission by an additional activated shift element (N) on the second countershaft (w_v2) so that at least one of a reverse gear (R2, R3, R4, R5), a crawler gear (C1) and an overdrive gear (O2) is shiftable by the at least one shift element (N) as a winding path gear.

10. The double clutch transmission according to claim 7, wherein the fixed gearwheels (1, 2, 3) of the second transmission input shaft (w_k2) of a second subtransmission are associated with a first gear plane (7-1) which is a single gear plane, a second gear plane (8-14) which is a dual gear plane, and a third gear plane (9-15) which is a dual gear plane, and the fixed gears (4, 5, 6) of the first transmission input shaft (w_k1) of a first subtransmission are associated with a fourth gear plane (10-16) which is a dual gear plane, a fifth gear plane (11-5) which is a single gear plane, and a sixth gear plane (6-18) which is a single gear plane.

11. The double clutch transmission according to claim 7, wherein the fixed gearwheels (1, 2, 3) of the second transmission input shaft (w_k2) of a second subtransmission are associated with a first gear plane (7-13) which is a dual gear plane, a second gear plane (8-2, 8-14) which is a single gear plane, and a third gear plane (9-15) which is a dual gear plane, and the fixed gears (4, 5, 6) of the first transmission input shaft (w k1) of a second subtransmission are associated with a fourth gear plane (10-16) which is a dual gear plane, a fifth gear plane (11-5) which is a single gear plane, and a sixth gear plane (6-18), which is a single gear plane.

12. The double clutch transmission according to claim 7, wherein the fixed gearwheels (1, 2, 3) of the second transmission input shaft (w_k2) of a second subtransmission are associated with a first gear plane (7-1, 1-13) which is a single gear plane, a second gear plane (2-14) which is a single gear plane, and a third gear plane (9-15) which is a dual gear plane, and the fixed gears (4, 5, 6) of the first transmission input shaft (w_k1) of a first subtransmission are associated with a fourth gear plane (10-16) which is a dual gear plane, a fifth gear plane (11-17) which is a dual gear plane, and a sixth gear plane (6-18, 12-6) which is a single gear plane.
